(19) United States
(12) Patent Application Publication
(10) Pub. No.: US 2021/0273714 A1
(43) Pub. Date: Sep. 2, 2021

(54) METHOD FOR INTELLIGENTLY TRACKING BEAM AND AUTONOMOUS VEHICLE THEREFOR

(71) Applicant: LG ELECTRONICS INC., Seoul (KR)

(72) Inventor: Kyungho LEE, Seoul (KR)

(73) Assignee: LG ELECTRONICS INC., Seoul (KR)

(21) Appl. No.: 17/153,554

(22) Filed: Jan. 20, 2021

(30) Foreign Application Priority Data
Feb. 21, 2020 (KR) 10-2020-0021454

(51) Int. Cl. H04B 7/08; H04W 16/28; H04W 76/11; H04W 4/40; H04W 56/00; H04B 17/318

(52) U.S. Cl. CPC H04B 7/088; H04W 16/28; H04B 17/318; H04W 4/40; H04W 56/001; H04W 76/11

(57) ABSTRACT

A method for an autonomous vehicle to intelligently track a beam in an autonomous system can include initiating a communication connection with a target vehicle; taking a target image including the target vehicle; synchronizing a plurality of candidate areas respectively related to a plurality of transmit (Tx) beams with the target image, the plurality of Tx beams transmitted to the target vehicle from the autonomous vehicle; identifying the target vehicle from among one or more objects in the target image based on information related to the target vehicle; selecting an optimal beam related to the target vehicle from among the plurality of Tx beams; and updating the optimal beam to be set to another Tx beam among the plurality of Tx beams based on a change in a location of the target vehicle in the target image.

### CROSS-REFERENCE TO RELATED APPLICATIONS

This application claims priority under 35 U.S.C. § 119 to Korean Patent Application No. 10-2020-0021454, filed in the Republic of Korea on Feb. 21, 2020, the disclosure of which is herein expressly incorporated by reference in its entirety into the present application.

### TECHNICAL FIELD

The present disclosure relates to a method for wireless communication of an autonomous vehicle in an autonomous system and an autonomous vehicle, and more particularly to a method for intelligently tracking a beam between target vehicles and an autonomous system.

### BACKGROUND

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and an autonomous system refers to a system that monitors and controls the autonomous vehicle such that the autonomous vehicle can perform self-driving.

The autonomous vehicle establishes communication connection with a target vehicle, and searches for an optimal beam for performing communication through a beam tracking operation with the target vehicle after the establishment. However, transmit (Tx) beam and/or receive (Rx) beam that are determined as the optimal beam may vary depending on changes in a relative location of each autonomous vehicle.

In a related art, a Tx autonomous vehicle periodically searches for an optimal Tx beam, and an Rx autonomous vehicle periodically searches for an optimal Rx beam. In such a situation, because the frequency of a sudden movement of each autonomous vehicle is faster than the speed at which each autonomous vehicle searches for an optimal beam, the probability of a beam failure is high. In addition, noise factor is added, and performance degradation becomes apparent.

### SUMMARY

An object of the present disclosure is to address the above-described and other needs and/or problems.

Another object of the present disclosure is to implement a method for efficiently searching for an optimal beam using a camera image between autonomous vehicles.

Another object of the present disclosure is to implement a method for accurately and rapidly searching for an optimal beam adaptively to changes in a relative location of a vehicle changing in real time using a determined optimal beam and an image for an opponent vehicle.

In one aspect of the present disclosure, there is provided a method for an autonomous vehicle to intelligently track a beam in an autonomous system, the method comprising initiating a communication connection with a target vehicle; taking a target image including the target vehicle; synchronizing a plurality of candidate areas respectively related to a plurality of transmit (Tx) beams transmitted to the target vehicle from the autonomous vehicle with the target image; identifying the target vehicle among a plurality of objects in the target image based on information related to the target vehicle; selecting an optimal beam related to the target vehicle from among the plurality of Tx beams; and updating the optimal beam based on changes in a location of the target vehicle in the target image.

The information related to the target vehicle may include information related to a received signal strength in the target vehicle for each of the plurality of Tx beams.

The information related to the target vehicle may include location information of the target vehicle.

The method may further comprise transmitting a first signal to the target vehicle, and the information related to the target vehicle may include information related to a reception direction for the first signal in the target vehicle.

The first signal may be a target vehicle specific signal for the target vehicle.

The method may further comprise receiving, from the target vehicle, a response signal to the first signal, and the information related to the target vehicle may include information related to a reception direction for the response signal in the autonomous vehicle.

The information related to the target vehicle may include identification information of the target vehicle.

In another aspect of the present disclosure, there is provided an autonomous vehicle comprising a processor configured to control a function of the autonomous vehicle; a memory coupled to the processor and configured to store data for control of the autonomous vehicle; and a communication unit coupled to the processor and configured to transmit and receive data for control of the autonomous vehicle, in which the memory is configured to store instructions that allow the processor to initiate a communication connection with a target vehicle, take a target image including the target vehicle, synchronize a plurality of candidate areas respectively related to a plurality of transmit (Tx) beams transmitted to the target vehicle from the autonomous vehicle with the target image, identify the target vehicle among a plurality of objects in the target image based on information related to the target vehicle, select an optimal beam related to the target vehicle from among the plurality of Tx beams, and update the optimal beam based on changes in a location of the target vehicle in the target image.

The information related to the target vehicle may include information related to a received signal strength in the target vehicle for each of the plurality of Tx beams.

The information related to the target vehicle may include location information of the target vehicle.

The processor may be further configured to transmit a first signal to the target vehicle, and the information related to the target vehicle may include information related to a reception direction for the first signal in the target vehicle.

The first signal may be a target vehicle specific signal for the target vehicle.

The processor may be further configured to receive, from the target vehicle, a response signal to the first signal, and the information related to the target vehicle may include information related to a reception direction for the response signal in the autonomous vehicle.

The information related to the target vehicle may include identification information of the target vehicle.

In another aspect of the present disclosure, there is provided a method for an autonomous vehicle to intelligently track a beam in an autonomous system, the method comprising initiating a communication connection with a target vehicle; taking a target image including the target vehicle; synchronizing a plurality of candidate areas respectively related to a plurality of receive (Rx) beams received to the autonomous vehicle from the target vehicle with the target image; identifying the target vehicle among a plurality of objects in the target image based on information related to the target vehicle; selecting an optimal beam related to the target vehicle from among the plurality of Rx beams; and updating the optimal beam based on changes in a location of the target vehicle in the target image.

Effects of an autonomous vehicle and a method of controlling the autonomous vehicle according to an embodiment of the present disclosure are described as follows.

Embodiments of the present disclosure can rapidly obtain location information of an opponent vehicle using a camera with a fast frame rate and can greatly reduce time required to measure candidate beams when performing a beam tracking operation between vehicles.

Embodiments of the present disclosure can rapidly select an optimal beam in response to changes in a relative location with an opponent vehicle by rapidly obtaining location information of the opponent vehicle using a camera image, and thus can minimize beam failure probability between two vehicles.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 illustrates a block diagram of configuration of a wireless communication system to which methods described in the present disclosure are applicable according to an embodiment.

FIG. 2 illustrates an example of a signal transmission/reception method in a wireless communication system according to an embodiment of the present disclosure.

FIG. 3 illustrates an example of an operation of an autonomous vehicle and a 5G network in a 5G communication system according to an embodiment of the present disclosure.

FIG. 4 illustrates an example of an operation between vehicles using 5G communication according to an embodiment of the present disclosure.

FIG. 5 illustrates a vehicle according to an embodiment of the present disclosure.

FIG. 6 is a control block diagram of a vehicle according to an embodiment of the present disclosure.

FIG. 7 is a control block diagram of an autonomous device according to an embodiment of the present disclosure.

FIG. 8 illustrates a signal flow in an autonomous vehicle according to an embodiment of the present disclosure.

FIG. 9 is a diagram for explaining a usage scenario of a user in accordance with an embodiment of the present disclosure.

FIG. 10 illustrates an example of V2X communication to which the present disclosure is applicable according to an embodiment.

FIG. 11 illustrates a method of allocating sources in a sidelink in which V2X is used according to an embodiment.

FIG. 12 illustrates an example of beamforming using a SSB and a CSI-RS according to an embodiment.

FIG. 13 illustrates an example of a uplink (UL) beam management (BM) procedure using a sounding reference signal (SRS) according to an embodiment.

FIG. 14 is a flow chart illustrating an example of a UL BM procedure using a SRS according to an embodiment.

FIG. 15 is a flow chart illustrating a method for controlling an autonomous vehicle according to an embodiment of the present disclosure.

FIG. 16 illustrates a process for a Tx user equipment (UE) to take a target image in accordance with an embodiment of the present disclosure.

FIG. 17 illustrates a process for an Rx UE to take a target image in accordance with an embodiment of the present disclosure.

FIG. 18 illustrates an example where a Tx UE identifies a target vehicle based on a received signal strength of an Rx UE in accordance with an embodiment of the present disclosure.

FIG. 19 illustrates an example where an Rx UE identifies a target vehicle based on a received signal strength of a Tx UE in accordance with an embodiment of the present disclosure.

FIG. 20 illustrates an example where a Tx UE identifies a target vehicle based on a location of an Rx UE in accordance with an embodiment of the present disclosure.

FIG. 21 illustrates an example where an Rx UE identifies a target vehicle based on a location of a Tx UE in accordance with an embodiment of the present disclosure.

FIG. 22 illustrates an example where a Tx UE identifies a target vehicle based on a response to an Rx UE specific signal of an Rx UE in accordance with an embodiment of the present disclosure.

FIG. 23 illustrates an example where an Rx UE identifies a target vehicle based on an Rx UE specific signal of a Tx UE in accordance with an embodiment of the present disclosure.

FIG. 24 illustrates an example where a Tx UE identifies a target vehicle based on a received signal angle of an Rx UE in accordance with an embodiment of the present disclosure.

FIG. 25 illustrates an example where an Rx UE identifies a target vehicle based on a received signal angle of an Rx UE in accordance with an embodiment of the present disclosure.

FIG. 26 illustrates an example of identifying a target vehicle using identification information on a target vehicle in accordance with an embodiment of the present disclosure.

### DETAILED DESCRIPTION OF THE EMBODIMENTS

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

### A. Example of Block Diagram of UE and 5G Network

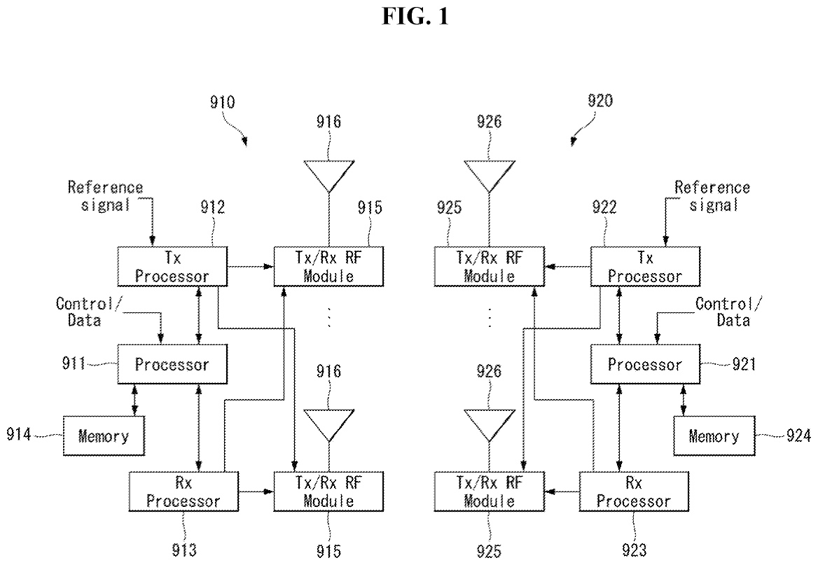

FIG. 1 illustrates a block diagram of configuration of a wireless communication system to which methods described in the present disclosure are applicable.

Referring to FIG. 1, a device (autonomous device) including an autonomous module is defined as a first communication device 910, and a processor 911 can perform detailed autonomous operations.

A 5G network including another vehicle communicating with the autonomous device is defined as a second communication device 920, and a processor 921 can perform detailed autonomous operations.

The 5G network may be represented as the first communication device, and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ULTRABOOK, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 respectively include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal via each antenna 926. The processor implements the functions, processes and/or methods described above. The processor 921 may be related to the memory 924 that stores program codes and data. The memory may be referred to as a computer-readable medium. More specifically, in downlink (DL) (communication from the first communication device to the second communication device), the Tx processor 912 implements various signal processing functions in L1 layer (e.g., physical layer). The Rx processor implements various signal processing functions of L1 layer (e.g., physical layer).

Uplink (UL) (communication from the second communication device to the first communication device) is processed in the first communication device 910 in a way similar to that described in association with a receiver function in the second communication device 920. Each Tx/Rx module 925 receives a signal via each antenna 926. Each Tx/Rx module provides RF carriers and information to the Rx processor 923. The processor 921 may be related to the memory 924 that stores program codes and data. The memory may be referred to as a computer-readable medium.

### B. Signal Transmission/Reception Method in Wireless Communication System

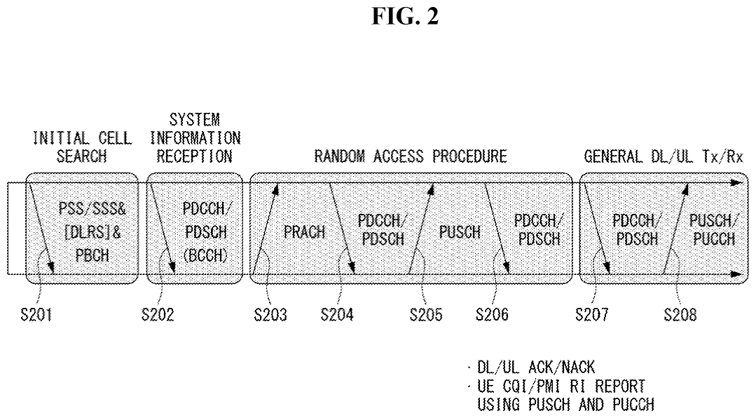

FIG. 2 illustrates physical channels and general signal transmission used in a 3GPP system.

In a wireless communication system, a UE receives information from a base station (BS) via downlink and transmits information to the base station via uplink. Information that the UE and the base station transmit and receive includes data and various control information, and various physical channels exist depending on type/use of information that the UE and the base station transmit and receive.

When the UE is powered on or enters a new cell, the UE performs an initial cell search operation, for example, synchronization with the base station in S201. For this operation, the UE may receive a primary synchronization signal (PSS) and a secondary synchronization signal (SSS) from the base station to synchronize with the base station and acquire information such as a cell ID. Afterwards, the UE may receive a physical broadcast channel (PBCH) from the base station to acquire broadcast information in the cell. The UE may receive a downlink reference signal (DL RS) in the initial cell search step to check a downlink channel state.

After the initial cell search, the UE may acquire more detailed system information by receiving a physical downlink shared channel (PDSCH) according to a physical downlink control channel (PDCCH) and information contained in the PDCCH, in S202.

When the UE initially accesses the BS or has no radio resource for signal transmission, the UE may perform a random access procedure (RACH) for the base station in S203 to S206. To this end, the UE may transmit a specific sequence as a preamble via a physical random access channel (PRACH) in S203 and S205, and receive a random access response (RAR) message for the preamble via the PDCCH and a corresponding PDSCH. In the situation of a contention-based RACH, a contention resolution procedure may be additionally performed in S206.

After the UE performs the above-described procedures, the UE may perform PDCCH/PDSCH reception (S207) and physical uplink shared channel (PUSCH)/physical uplink control channel (PUCCH) transmission (S208), as a normal uplink/downlink signal transmission procedure. Particularly, the UE may receive downlink control information (DCI) via the PDCCH. The DCI includes control information such as resource allocation information for the UE, and different formats may be applied to the DCI depending on the use purpose.

Control information that the UE transmits to the base station via uplink or receives from the base station via uplink may include downlink/uplink ACK/NACK signal, a channel quality indicator (CQI), a precoding matrix index (PMI), a rank indicator (RI), and the like. The UE may transmit the control information such as CQI/PMI/RI via PUSCH and/or PUCCH.

An initial access (IA) procedure in a 5G communication system is additionally described with reference to FIG. 2.

The UE can perform cell search, system information acquisition, beam alignment for initial access, and DL measurement based on an SSB. The SSB is interchangeably used with a synchronization signal/physical broadcast channel (SS/PBCH) block.

The SSB includes a PSS, an SSS and a PBCH. The SSB consists of four consecutive OFDM symbols, and the PSS, the PBCH, the SSS/PBCH or the PBCH is transmitted per OFDM symbol. Each of the PSS and the SSS consists of one OFDM symbol and 127 subcarriers, and the PBCH consists of 3 OFDM symbols and 576 subcarriers.

The cell search refers to a process in which a UE acquires time/frequency synchronization of a cell and detects a cell identifier (ID) (e.g., physical layer cell ID (PCI)) of the cell. The PSS is used to detect a cell ID from a cell ID group, and the SSS is used to detect a cell ID group. The PBCH is used to detect an SSB (time) index and a half-frame.

There are 336 cell ID groups, and there are 3 cell IDs per cell ID group. A total of 1008 cell IDs are present. Information on a cell ID group to which a cell ID of a cell belongs is provided/acquired via an SSS of the cell, and information on the cell ID among 336 cell ID groups is provided/acquired via a PSS.

The SSB is periodically transmitted in accordance with SSB periodicity. A default SSB periodicity assumed by the UE during initial cell search is defined as 20 ms. After cell access, the SSB periodicity may be set to one of {5 ms, 10 ms, 20 ms, 40 ms, 80 ms, 160 ms} by a network (e.g., a BS).

Next, acquisition of system information (SI) is described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS via a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (e.g., SI-window).

A random access (RA) procedure in the 5G communication system is additionally described with reference to FIG. 2.

A random access procedure is used for various purposes. For example, the random access procedure can be used for network initial access, handover, and UE-triggered UL data transmission. The UE can acquire UL synchronization and UL transmission resources through the random access procedure. The random access procedure is classified into a contention-based random access procedure and a contention-free random access procedure. A detailed procedure for the contention-based random access procedure is as follows.

The UE can transmit a random access preamble via PRACH as Msg1 of a random access procedure in UL. Random access preamble sequences with two different lengths are supported. Long sequence length 839 is applied to subcarrier spacings of 1.25 kHz and 5 kHz, and short sequence length 139 is applied to subcarrier spacings of 15 kHz, 30 kHz, 60 kHz and 120 kHz.

When a BS receives the random access preamble from the UE, the BS sends a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, e.g., Msg1. Presence or absence of random access information with respect to Msg1 transmitted by the UE can be determined depending on presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission based on most recent path loss and a power ramping counter.

The UE can perform UL transmission as Msg3 of the random access procedure on a physical uplink shared channel based on the random access response information. The Msg3 may include an RRC connection request and a UE ID. The network may transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure may be divided into (1) a DL BM procedure using an SSB or a CSI-RS and (2) a UL BM procedure using a sounding reference signal (SRS). In addition, each BM procedure may include Tx beam swiping for determining a Tx beam and Rx beam swiping for determining an Rx beam.

The DL BM procedure using an SSB is described.

Configuration for a beam report using an SSB is performed upon configuration of channel state information (CSI)/beam in RRC CONNECTED.
A UE receives, from a BS, a CSI-ResourceConfig IE including CSI-SSB-ResourceSetList for SSB resources used for BM. The RRC parameter “csi-SSB-ResourceSetList” represents a list of SSB resources used for beam management and report in one resource set. An SSB resource set may be configured as {SSBx1, SSBx2, SSBx3, SSBx4, . . . }. An SSB index may be defined in the range of 0 to 63.
The UE receives, from the BS, signals on SSB resources based on CSI-SSB-ResourceSetList.
When CSI-RS reportConfig related to a report for SSBRI and reference signal received power (RSRP) is configured, the UE reports the best SSBRI and RSRP corresponding to this to the BS. For example, when reportQuantity of the CSI-RS reportConfig IE is configured to ‘ssb-Index-RSRP’, the UE reports the best SSBRI and RSRP corresponding to this to the BS.

When CSI-RS resource is configured to the same OFDM symbol(s) as SSB and ‘QCL-TypeD’ is applicable, the UE may assume that the CSI-RS and the SSB are quasi co-located (QCL) from the viewpoint of ‘QCL-TypeD’. Here, ‘QCL-TypeD’ may mean that antenna ports are quasi co-located from the viewpoint of a spatial Rx parameter. When the UE receives signals of a plurality of DL antenna ports with a QCL-TypeD relationship, the same Rx beam can be applied.

Next, a DL BM procedure using a CSI-RS is described.

An Rx beam determination (or refinement) procedure of the UE and a Tx beam swiping procedure of the BS using a CSI-RS are sequentially described. A repetition parameter is set to ‘ON’ in the Rx beam determination procedure of the UE, and is set to ‘OFF’ in the Tx beam swiping procedure of the BS.

First, the Rx beam determination procedure of the UE is described.
The UE receives, from the BS, an NZP CSI-RS resource set IE including an RRC parameter for ‘repetition’ via RRC signaling. The RRC parameter ‘repetition’ is set to ‘ON’.
The UE repeatedly receives signals on resource(s) in a CSI-RS resource set, in which the RRC parameter ‘repetition’ is set to ‘ON’, in different OFDM symbols through the same Tx beam (or DL spatial domain transmission filter) of the BS.
The UE determines its RX beam.
The UE skips a CSI report. That is, the UE may skip a CSI report when the RRC parameter ‘repetition’ is set to ‘ON’.

Next, the Tx beam determination procedure of the BS is described.
The UE receives, from the BS, an NZP CSI-RS resource set IE including an RRC parameter for ‘repetition’ via RRC signaling. The RRC parameter ‘repetition’ is set to ‘OFF’ and is related to the Tx beam swiping procedure of the BS.
The UE receives signals on resources in a CSI-RS resource set, in which the RRC parameter ‘repetition’ is set to ‘OFF’, in different Tx beams (DL spatial domain transmission filter) of the BS.
The UE selects (or determines) a best beam.
The UE reports an ID (e.g., CRI) of the selected beam and related quality information (e.g., RSRP) to the BS. That is, when a CSI-RS is transmitted for the BM, the UE reports a CRI and RSRP with respect thereto to the BS.

Next, the UL BM procedure using an SRS is described.
The UE receives, from the BS, RRC signaling (e.g., SRS-Config IE) including a (RRC parameter) purpose parameter configured to ‘beam management”. The SRS-Config IE is used to configure SRS transmission. The SRS-Config IE includes a list of SRS-Resources and a list of SRS-ResourceSets. Each SRS resource set refers to a set of SRS-resources.

The UE determines Tx beamforming for SRS resources to be transmitted based on SRS-SpatialRelation Info included in the SRS-Config IE. SRS-SpatialRelation Info is configured per SRS resource and represents whether the same beamforming as beamforming used for an SSB, a CSI-RS or an SRS is applied per each SRS resource.
When SRS-SpatialRelationInfo is configured for SRS resources, the same beamforming as beamforming used for the SSB, CSI-RS or SRS is applied and transmitted. However, when SRS-SpatialRelationInfo is not configured for SRS resources, the UE randomly determines Tx beamforming and transmits an SRS through the determined Tx beamforming.

Next, a beam failure recovery (BFR) procedure is described.

In a beamformed system, radio link failure (RLF) may frequently occur due to rotation, movement or beamforming blockage of the UE. Thus, BFR is supported in NR to prevent frequent occurrence of RLF. The BFR is similar to a radio link failure recovery procedure and may be supported when the UE knows new candidate beam(s). For beam failure detection, the BS configures beam failure detection reference signals to the UE, and the UE declares beam failure when the number of beam failure indications from the physical layer of the UE reaches a threshold configured via RRC signaling within a period configured via RRC signaling of the BS. After the beam failure detection, the UE triggers beam failure recovery by initiating a random access procedure on PCell and performs the beam failure recovery by selecting a suitable beam (when the BS provides dedicated random access resources for certain beams, these are prioritized by the UE). The completion of the random access procedure is regarded as completion of beam failure recovery.

### D. Ultra-Reliable and Low Latency Communication (URLLC)

URLLC transmission defined in NR may refer to (1) a relatively low traffic size, (2) a relatively low arrival rate, (3) extremely low latency requirements (e.g., 0.5 ms and 1 ms), (4) relatively short transmission duration (e.g., 2 OFDM symbols), (5) urgent services/messages, etc. In UL, transmission of traffic of a specific type (e.g., URLLC) needs to be multiplexed with another transmission (e.g., eMBB) scheduled in advance in order to satisfy more stringent latency requirements. In this regard, a method is provided, which provides information indicating preemption of specific resources to the pre-scheduled UE and allows a URLLC UE to use the corresponding resources for UL transmission.

NR supports dynamic resource sharing between eMBB and URLLC. eMBB and URLLC services may be scheduled on non-overlapping time/frequency resources, and URLLC transmission may occur in resources scheduled for ongoing eMBB traffic. An eMBB UE may not ascertain whether PDSCH transmission of the corresponding UE has been partially punctured, and the UE may not decode a PDSCH due to corrupted coded bits. In view of this, NR provides a preemption indication. The preemption indication may also be referred to as an interrupted transmission indication.

With regard to the preemption indication, the UE receives DownlinkPreemption IE via RRC signaling from the BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of locations for fields in DCI format 2_1 according to a set of serving cells and positionInDCI by INT-ConfigurationPerServing Cell including a set of serving cell indexes provided by servingCellID, is configured with an information payload size for DCI format 2_1 by dci-Payloadsize, and is configured with indication granularity of time-frequency resources by timeFrequency Sect.

The UE receives, from the BS, DCI format 2_1 based on the DownlinkPreemption IE.

When the UE detects DCI format 2_1 for a serving cell in a configured set of serving cells, the UE may assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in time-frequency resources indicated by preemption is not DL transmission scheduled to the UE, and decodes data based on signals received in the remaining resource region.

### E. Massive MTC (mMTC)

Massive machine type communication (mMTC) is one of 5G scenarios for supporting a hyper-connection service that simultaneously communicate with a large number of UEs. In this environment, a UE intermittently performs communication with a very low speed and mobility. Thus, a main goal of mMTC is operating the UE for a long time at a low cost. In regard to mMTC technology, 3GPP deals with MTC and narrowband (NB)-IoT.

The mMTC technology has features such as repetitive transmission, frequency hopping, retuning, and a guard period of a PDCCH, a PUCCH, a physical downlink shared channel (PDSCH), a PUSCH, etc.

That is, PUSCH (or PUCCH (particularly, long PUCCH) or a PRACH) including specific information and PDSCH (or PDCCH) including a response to the specific information are repeatedly transmitted. The repetitive transmission is performed through frequency hopping. For the repetitive transmission, (RF) retuning from a first frequency resource to a second frequency resource is performed in the guard period, and the specific information and the response to the specific information may be transmitted/received through a narrowband (e.g., 6 resource blocks (RBs) or 1 RB).

### F. Basic Operation Between Autonomous Vehicles Using 5G Communication

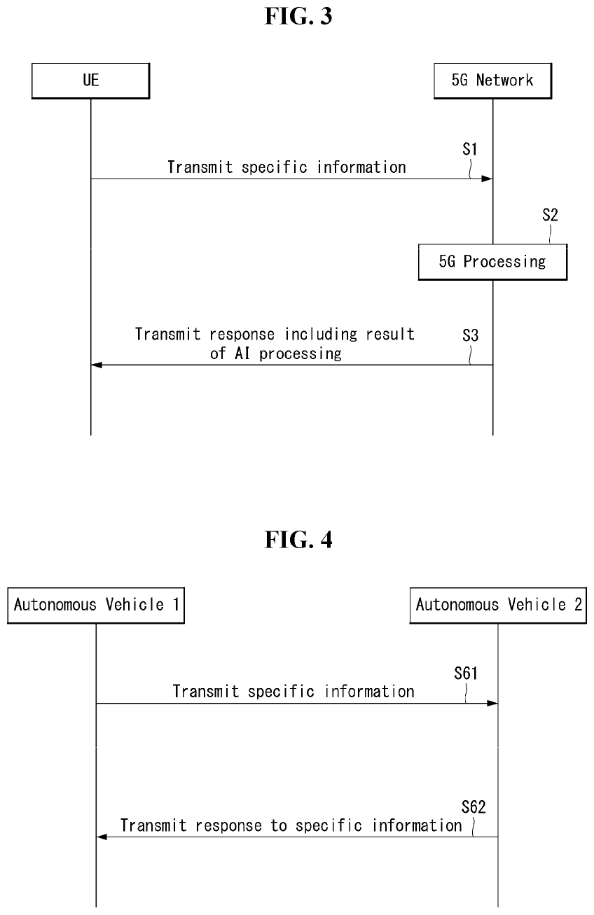

FIG. 3 illustrates an example of a basic operation of an autonomous vehicle and a 5G network in a 5G communication system.

An autonomous vehicle transmits specific information to the 5G network in S1. The specific information may include autonomous driving related information. The 5G network may determine whether to remotely control the vehicle in S2. The 5G network may include a server or a module which performs remote control related to autonomous driving. In addition, the 5G network may transmit information (or signal) related to remote control to the autonomous vehicle in S3.

### G. Applied Operation Between Autonomous Vehicle and 5G Network in 5G Communication System

An operation of an autonomous vehicle using 5G communication is described in more detail below with reference to the wireless communication technology (BM procedure, URLLC, mMTC, etc.) described in FIGS. 1 and 2.

First, a basic procedure of an applied operation, to which a method according to the present disclosure to be described later and eMBB of 5G communication are applied, is described.

As in steps S1 and S3 of FIG. 3, the autonomous vehicle performs an initial access procedure and a random access procedure with the 5G network prior to step S1 of FIG. 3, in order to transmit/receive signals, information and the like to/from the 5G network.

More specifically, the autonomous vehicle performs an initial access procedure with the 5G network based on SSB, in order to acquire DL synchronization and system information. A beam management (BM) procedure and a beam failure recovery procedure may be added in the initial access procedure, and a quasi-co-location (QCL) relationship may be added in a process in which the autonomous vehicle receives a signal from the 5G network.

In addition, the autonomous vehicle performs a random access procedure with the 5G network for UL synchronization acquisition and/or UL transmission. The 5G network may transmit, to the autonomous vehicle, a UL grant for scheduling transmission of specific information. Thus, the autonomous vehicle transmits the specific information to the 5G network based on the UL grant. In addition, the 5G network transmits, to the autonomous vehicle, a DL grant for scheduling transmission of a result of 5G processing for the specific information. Thus, the 5G network may transmit, to the autonomous vehicle, information (or a signal) related to remote control based on the DL grant.

Next, a basic procedure of an applied operation, to which a method according to the present disclosure to be described later and URLLC of 5G communication are applied, is described.

As described above, the autonomous vehicle may receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network based on DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle may receive a UL grant from the 5G network.

Next, a basic procedure of an applied operation, to which a method according to the present disclosure to be described later and mMTC of 5G communication are applied, is described.

Description will focus on parts in the steps of FIG. 3 which are changed according to application of mMTC.

In step S1 of FIG. 3, the autonomous vehicle receives a UL grant from the 5G network in order to transmit specific information to the 5G network. The UL grant may include information on the number of repetitions of transmission of the specific information, and the specific information may be repeatedly transmitted based on the information on the number of repetitions. That is, the autonomous vehicle transmits the specific information to the 5G network based on the UL grant. The repetitive transmission of the specific information may be performed through frequency hopping, the first transmission of the specific information may be performed in a first frequency resource, and the second transmission of the specific information may be performed in a second frequency resource. The specific information may be transmitted on a narrowband of 6 resource blocks (RBs) or 1 RB.

### H. Autonomous Driving Operation Between Vehicles Using 5G Communication

FIG. 4 illustrates an example of a basic operation between vehicles using 5G communication.

A first vehicle transmits specific information to a second vehicle in S61. The second vehicle transmits a response to the specific information to the first vehicle in S62.

Configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication is described.

First, a method in which a 5G network is directly involved in resource allocation for signal transmission/reception between vehicles is described.

The 5G network may transmit DCI format 5A to the first vehicle for scheduling of mode-3 transmission (PSCCH and/or PSSCH transmission). The physical sidelink control channel (PSCCH) is a 5G physical channel for scheduling of transmission of specific information, and the physical sidelink shared channel (PSSCH) is a 5G physical channel for transmission of specific information. In addition, the first vehicle transmits, to the second vehicle, SCI format 1 for scheduling of specific information transmission on PSCCH. Then, the first vehicle transmits the specific information to the second vehicle on PSSCH.

Next, a method in which a 5G network is indirectly involved in resource allocation for signal transmission/reception is described.

The first vehicle senses resources for mode-4 transmission in a first window. Then, the first vehicle selects resources for mode-4 transmission in a second window based on a result of sensing. The first window refers to a sensing window, and the second window refers to a selection window. The first vehicle transmits, to the second vehicle, SCI format 1 for scheduling of transmission of specific information on PSCCH based on the selected resources. Then, the first vehicle transmits the specific information to the second vehicle on PSSCH.

The above-described 5G communication technology can be combined with methods according to the present disclosure to be described later and applied, or can complement methods described in the present disclosure to make technical features of the methods concrete and clear.

Driving

(1) Exterior of Vehicle

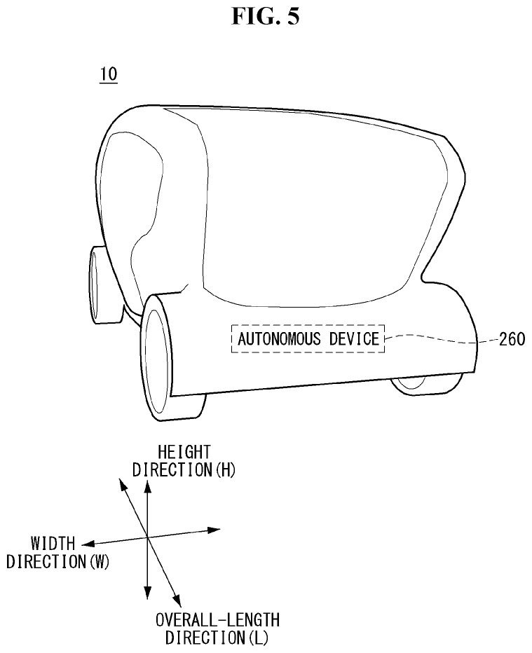

FIG. 5 illustrates a vehicle according to an embodiment of the present disclosure.

Referring to FIG. 5, a vehicle 10 according to an embodiment of the present disclosure is defined as a transportation means traveling on roads or railroads. The vehicle 10 includes a car, a train, and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

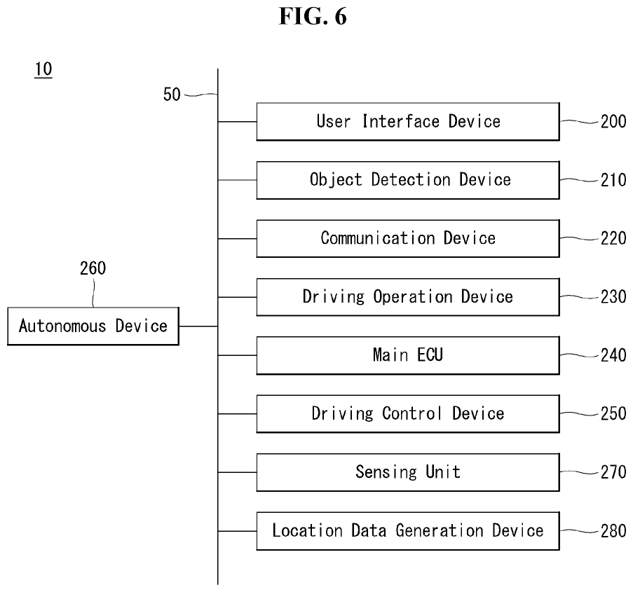

FIG. 6 is a control block diagram of a vehicle according to an embodiment of the present disclosure.

Referring to FIG. 6, a vehicle 10 may include a user interface device 200, an object detection device 210, a communication device 220, a driving operation device 230, a main ECU 240, a driving control device 250, an autonomous device 260, a sensing unit 270, and a location data generation device 280. Each of the object detection device 210, the communication device 220, the driving operation device 230, the main ECU 240, the driving control device 250, the autonomous device 260, the sensing unit 270, and the location data generation device 280 may be implemented as an electronic device which generates electric signals and exchange the electric signals from one another.

1) User Interface Device

The user interface device 200 is a device for communication between the vehicle 10 and a user. The user interface device 200 may receive a user input and provide information generated in the vehicle 10 to the user. The vehicle 10 may implement a user interface (UI) or user experience (UX) through the user interface device 200. The user interface device 200 may include an input device, an output device, and a user monitoring device.

2) Object Detection Device

The object detection device 210 may generate information about objects outside the vehicle 10. The information about objects may include at least one of information on presence or absence of the object, location information of the object, information on a distance between the vehicle 10 and the object, and information on a relative speed of the vehicle 10 with respect to the object. The object detection device 210 may detect objects outside the vehicle 10. The object detection device 210 may include at least one sensor which may detect objects outside the vehicle 10. The object detection device 210 may include at least one of a camera, a radar, a lidar, an ultrasonic sensor, and an infrared sensor. The object detection device 210 may provide data for an object generated based on a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects based on the processed signals.

The camera may be at least one of a mono camera, a stereo camera and an around view monitoring (AVM) camera. The camera can acquire location information of objects, information on distances to objects, or information on relative speeds with respect to objects using various image processing algorithms. For example, the camera can acquire information on a distance to an object and information on a relative speed with respect to the object from an acquired image based on change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera based on disparity information.

The camera may be attached at a portion of the vehicle at which FOV (field of view) can be secured in order to photograph the outside of the vehicle. The camera may be disposed in proximity to the front windshield inside the vehicle in order to acquire front images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information on an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object based on the processed signals. The radar may be implemented as a pulse radar or a continuous wave radar in terms of electromagnetic wave emission. The continuous wave radar may be implemented as a frequency modulated continuous wave (FMCW) radar or a frequency shift keying (FSK) radar according to signal waveform. The radar can detect an object by means of electromagnetic waves based on a time of flight (TOF) method or a phase shift method, and detect a location of the detected object, a distance to the detected object, and a relative speed with respect to the detected object. The radar may be disposed at an appropriate location outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object based on the processed signal. The lidar may be implemented by the TOF method or the phase shift method. The lidar may be implemented in a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object be means of laser beams based on the TOF method or the phase shift method and detect the location of the detected object, a distance to the detected object, and a relative speed with respect to the detected object. The lidar may be disposed at an appropriate location outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle, and a terminal. The communication device 220 may include a transmission antenna, a reception antenna, and at least one of a radio frequency (RF) circuit and an RF element, which can implement various communication protocols, in order to perform communication.

For example, the communication device can exchange signals with external devices based on C-V2X (Cellular V2X). For example, C-V2X can include sidelink communication based on LTE and/or sidelink communication based on NR. Details related to C-V2X will be described later.

For example, the communication device can exchange signals with external devices based on dedicated short range communications (DSRC) or wireless access in vehicular environment (WAVE) standards based on IEEE 802.11p PHY/MAC layer technology and IEEE 1609 Network/Transport layer technology. The DSRC (or WAVE standards) is communication specifications for providing an intelligent transport system (ITS) service through short-range dedicated communication between vehicle-mounted devices or between a roadside device and a vehicle-mounted device. The DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven based on a signal provided by the driving operation device 230. The driving operation device 230 may include a steering input device (e.g., a steering wheel), an acceleration input device (e.g., an acceleration pedal), and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. The safety device driving control device may include a seat belt driving control device for seat belt control.

The driving control device 250 includes at least one electronic control device (e.g., a control electronic control unit (ECU)).

The driving control device 250 can control vehicle driving devices based on signals received by the autonomous device 260. For example, the driving control device 250 can control a power train, a steering device and a brake device based on signals received by the autonomous device 260.

7) Autonomous Device

The autonomous device 260 can generate a route for self-driving based on acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one advanced driver assistance system (ADAS) function. The ADAS can implement at least one of adaptive cruise control (ACC), autonomous emergency braking (AEB), forward collision warning (FCW), lane keeping assist (LKA), lane change assist (LCA), target following assist (TFA), blind spot detection (BSD), high beam assist (HBA), auto parking system (APS), a PD collision warning system, traffic sign recognition (TSR), traffic sign assist (TSA), night vision (NV), driver status monitoring (DSM), and traffic jam assist (TJA).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode based on a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a location module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The sensing unit 270 can generate vehicle state data based on a signal generated from at least one sensor. The vehicle state data may be information generated based on data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Location Data Generation Device

The location data generation device 280 can generate location data of the vehicle 10. The location data generation device 280 may include at least one of a global positioning system (GPS) and a differential global positioning system (DGPS). The location data generation device 280 can generate location data of the vehicle 10 based on a signal generated from at least one of the GPS and the DGPS. According to an embodiment, the location data generation device 280 can correct location data based on at least one of the inertial measurement unit (IMU) sensor of the sensing unit 270 and the camera of the object detection device 210. The location data generation device 280 may also be called a global navigation satellite system (GNSS).

The vehicle 10 may include an internal communication system 50. The plurality of electronic devices included in the vehicle 10 may exchange signals through the internal communication system 50. The signals may include data. The internal communication system 50 may use at least one communication protocol (e.g., CAN, LIN, FlexRay, MOST or Ethernet).

(3) Components of Autonomous Device

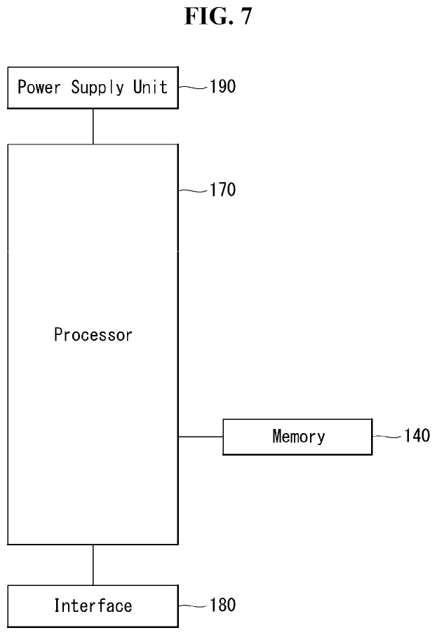

FIG. 7 is a control block diagram of an autonomous device according to an embodiment of the present disclosure.

Referring to FIG. 7, the autonomous device 260 may include a memory 140, a processor 170, an interface 180, and a power supply unit 190.

The memory 140 is electrically connected to the processor 170. The memory 140 can store basic data for units, control data for operation control of units, and input/output data. The memory 140 can store data processed in the processor 170. Hardware-wise, the memory 140 may be configured as at least one of a ROM, a RAM, an EPROM, a flash drive and a hard drive. The memory 140 may store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 may exchange signals with at least one electronic device included in the vehicle 10 in a wired or wireless manner. The interface 180 may exchange signals with at least one of the object detection device 210, the communication device 220, the driving operation device 230, the main ECU 240, the driving control device 250, the sensing unit 270 and the location data generation device 280 in a wired or wireless manner. The interface 180 may be configured using at least one of a communication module, a terminal, a pin, a cable, a port, a circuit, an element, and a device.

The power supply unit 190 may supply power to the autonomous device 260. The power supply unit 190 may be supplied with power from a power source (e.g., a battery) included in the vehicle 10 and may supply the power to each unit of the autonomous device 260. The power supply unit 190 may operate in response to a control signal supplied from the main ECU 240. The power supply unit 190 may include a switched-mode power supply (SMPS).

The processor 170 may be electrically connected to the memory 140, the interface 180, and the power supply unit 190 and exchange signals with these components. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 may operate by power supplied from the power supply unit 190. The processor 170 may receive data, process the data, generate a signal and provide the signal in a state in which power is supplied.

The processor 170 may receive information from other electronic devices included in the vehicle 10 via the interface 180. The processor 170 may provide control signals to other electronic devices in the vehicle 10 via the interface 180.

The autonomous device 260 may include at least one printed circuit board (PCB). The memory 140, the interface 180, the power supply unit 190 and the processor 170 may be electrically connected to the PCB.

(4) Operation of Autonomous Device

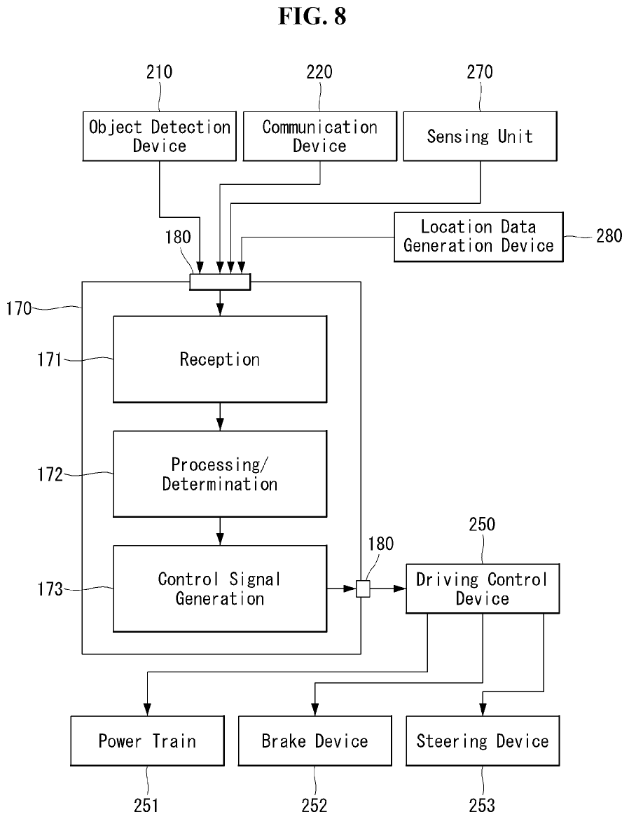

FIG. 8 illustrates a signal flow of an autonomous vehicle according to an embodiment of the present disclosure.

1) Reception Operation

Referring to FIG. 8, the processor 170 may perform a reception operation. The processor 170 may receive data from at least one of the object detection device 210, the communication device 220, the sensing unit 270, and the location data generation device 280 via the interface 180. The processor 170 may receive object data from the object detection device 210. The processor 170 may receive HD map data from the communication device 220. The processor 170 may receive vehicle state data from the sensing unit 270. The processor 170 can receive location data from the location data generation device 280.

2) Processing/Determination Operation

The processor 170 may perform a processing/determination operation. The processor 170 may perform the processing/determination operation based on traveling situation information. The processor 170 may perform the processing/determination operation based on at least one of object data, HD map data, vehicle state data and location data.

2.1) Driving Plan Data Generation Operation

The processor 170 may generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located based on a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated based on data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated based on a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data may include a main path and a sub-path. The main path may be understood as a trajectory obtained by connecting roads having a high relative probability of being selected. The sub-path may be branched from at least one decision point on the main path. The sub-path may be understood as a trajectory obtained by connecting at least one road having a low relative probability of being selected at least one decision point on the main path.

3) Control Signal Generation Operation

The processor 170 can perform a control signal generation operation. The processor 170 can generate a control signal based on the electronic horizon data. For example, the processor 170 may generate at least one of a power train control signal, a brake device control signal and a steering device control signal based on the electronic horizon data.

The processor 170 may transmit the generated control signal to the driving control device 250 via the interface 180. The driving control device 250 may transmit the control signal to at least one of a power train 251, a brake device 252, and a steering device 254.

Autonomous Vehicle Usage Scenario

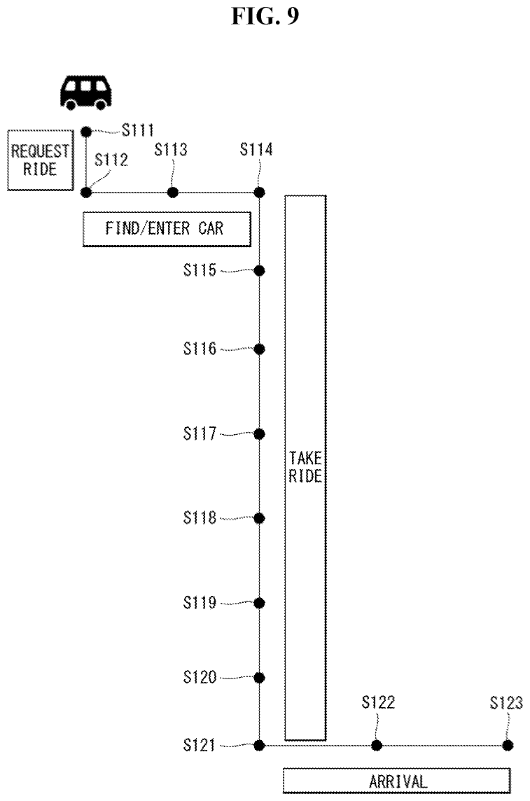

FIG. 9 is a diagram for explaining a usage scenario of a user in accordance with an embodiment of the present disclosure.

1) Destination Prediction Scenario

A first scenario S111 is a scenario for prediction of a destination of a user. An application which can operate in connection with a cabin system 300 can be installed in a user terminal. The user terminal can predict a destination of a user based on user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

A seat system 360 can configure a cabin interior layout based on at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may implement a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user based on acquired body information.

5) Personal Content Provision Scenario

A fifth scenario S115 is a personal content provision scenario. A display system 350 can receive user personal data through an input device 310 or the communication device 330. The display system 350 can provide content corresponding to the user personal data.

6) Item Provision Scenario

A sixth scenario S116 is an item provision scenario. A cargo system 355 can receive user data through the input device 310 or the communication device 330. The user data may include user preference data, user destination data, etc. The cargo system 355 can provide items based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a price for use of the vehicle by the user based on the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed based on the electrical signal.

9) AI Agent Scenario

A ninth scenario S119 is a multi-channel artificial intelligence (AI) agent scenario for a plurality of users. An AI agent 372 can distinguish a user input per each of a plurality of users. The AI agent 372 can control at least one of the display system 350, the cargo system 355, the seat system 360, and the payment system 365 in response to electrical signals obtained by converting an individual user input from the plurality of users.

10) Multimedia Content Provision Scenario for Multiple Users

A tenth scenario S120 is a multimedia content provision scenario for a plurality of users. The display system 350 can provide content that can be viewed by all users together. In this situation, the display system 350 can individually provide the same sound to the plurality of users through speakers provided for respective seats. The display system 350 can provide content that can be individually viewed by the plurality of users. In this situation, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle based on the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data may include data about a total charge for using the vehicle 10.

Vehicle-to-Everything (V2X)

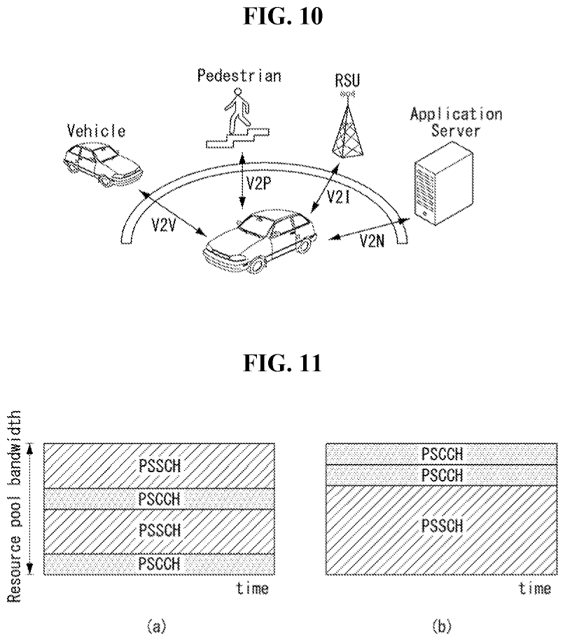

FIG. 10 illustrates an example of V2X communication to which the present disclosure is applicable.

V2X communication includes communication between a vehicle and any entity, such as vehicle-to-vehicle (V2V) referring to communication between vehicles, vehicle-to-infrastructure (V21) referring to communication between a vehicle and an eNB or a road side unit (RSU), vehicle-to-pedestrian (V2P) referring to communication between a vehicle and a UE carried by a person (e.g., pedestrian, bicycle driver, vehicle driver, or passenger), and vehicle-to-network (V2N).

The V2X communication may refer to the same meaning as V2X sidelink or NR V2X or refer to a wider meaning including V2X sidelink or NR V2X.

The V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

The V2X communication may be provided via a PC5 interface and/or a Uu interface. In this situation, specific network entities for supporting communication between the vehicle and all the entities may be present in a wireless communication system supporting the V2X communication. For example, the network entity may be a BS (eNB), a road side unit (RSU), a UE, or an application server (e.g., traffic safety server), etc.

Further, the UE performing the V2X communication may refer to a vehicle UE (V-UE), a pedestrian UE, a BS type (eNB type) RSU, a UE type RSU, and a robot with a communication module as well as a handheld UE.

The V2X communication may be directly performed between UEs or performed through the network entities. V2X operation modes may be categorized according to a method of performing the V2X communication.

The V2X communication is required to support pseudonymity and privacy of UEs when a V2X application is used so that an operator or a third party cannot track a UE identifier within an area in which V2X is supported.

The terms frequently used in the V2X communication are defined as follows.
Road Side Unit (RSU): the RSU is a V2X service enabled device which can perform transmission/reception with moving vehicles using a V21 service. In addition, the RSU is a fixed infrastructure entity supporting a V2X application and can exchange messages with other entities supporting the V2X application. The RSU is a term frequently used in conventional ITS specifications and is introduced to 3GPP specifications in order to allow documents to be able to be read more easily in ITS industry. The RSU is a logical entity which combines V2X application logic with the function of a BS (BS-type RSU) or a UE (UE-type RSU).
V2I service: A type of V2X service having a vehicle as one side and an entity belonging to infrastructures as the other side.
V2P service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

FIG. 11 illustrates a method of allocating sources in a sidelink in which V2X is used.

As illustrated in FIG. 11(a), on sidelink, different physical sidelink control channels (PSCCHs) may be spaced and allocated in the frequency domain, and different physical sidelink shared channels (PSSCHs) may be spaced and allocated. Alternatively, as illustrated in FIG. 11(b), different PSCCHs may be continuously allocated in the frequency domain, and PSSCHs may also be continuously allocated in the frequency domain.

NR V2X

To extend 3GPP platform to auto industry during 3GPP Release 14 and 15, support for V2V and V2X services has been introduced in LTE.

Requirements for support for enhanced V2X use cases are arranged into four use example groups.

(1) Vehicle platooning enables dynamic formation of a platoon in which vehicles move together. All vehicles in a platoon obtain information from the leading vehicle in order to manage the platoon. Such information allows vehicles to travel in harmony rather than traveling in a normal direction and to move together in the same direction.

(2) Extended sensors allow vehicles, road side units, pedestrian devices and V2X application servers to exchange raw data or processed data collected through local sensors or live video images. A vehicle can enhance recognition of environment beyond a level that can be detected by a sensor thereof and can ascertain local circumstances more extensively and generally. A high data transfer rate is one of major characteristics.

(3) Advanced driving enables semi-automatic or full-automatic driving. Each vehicle and/or RSU share data recognized thereby and obtained from local sensors with a neighboring vehicle, and a vehicle can synchronize and adjust a trajectory or maneuver. Each vehicle shares driving intention with a neighboring traveling vehicle.

(4) Remote driving enables a remote driver or a V2X application to drive a remote vehicle for a passenger who cannot drive or cannot drive a remote vehicle in a dangerous environment. When changes are limited and routes can be predicted such as public transportation, driving based on cloud computing can be used. High reliability and low latency time are major requirements.

### I. Beam Management (BM)

A BM procedure, as layer 1 (L1)/layer 2 (L2) procedures for obtaining and maintaining a set of base station (e.g., gNB, TRP, etc.) and/or terminal (e.g., UE) beams available for downlink (DL) and uplink (UL) transmission/reception, may include the following procedures and terms.
Beam measurement: operation that the base station or the UE measures the characteristics of a received beamformed signal.
Beam determination: operation that the base station or the UE selects its transmit beam (Tx beam)/receive beam (Rx beam).
Beam sweeping: operation that covers a space region using the Tx beam/Rx beam for a predetermined time interval in a predetermined manner.
Beam report: operation that the UE reports information on a beamformed signal based on the beam measurement.

The BM procedure may be divided into (1) a DL BM procedure that uses synchronization signal (SS)/physical broadcast channel (PBCH) block or CSI-RS, and (2) an UL BM procedure that uses a sounding reference signal (SRS). Further, each BM procedure may include Tx beam sweeping for determining the Tx beam and RX beam sweeping for determining the Rx beam.

DL BM Procedure

A DL BM procedure may include (1) a step for a base station to transmit a beamforming DL reference signal (RS) (e.g., CSI-RS or SS block (SSB)), and (2) a step for a UE to transmit a beam reporting.

The beam reporting may include preferred DL RS identifier(s) (ID) and its corresponding L1-reference signal received power (RSRP).

The DL RS ID may be a SSB resource indicator (SSBRI) or a CSI-RS resource indicator (CRI).

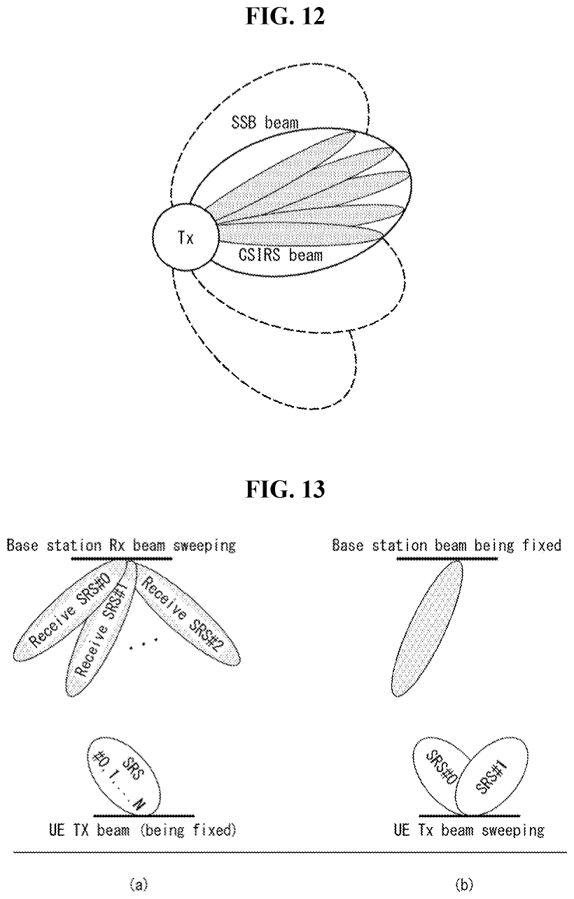

FIG. 12 illustrates an example of beamforming using a SSB and a CSI-RS.

As illustrated in FIG. 12, a SSB beam and a CSI-RS beam may be used for beam measurement. A measurement metric is L1-RSRP per resource/block. The SSB may be used for coarse beam measurement, and the CSI-RS may be used for fine beam measurement. The SSB may be used for both Tx beam sweeping and Rx beam sweeping. The Rx beam sweeping using the SSB may be performed while the UE changes Rx beam for the same SSBRI across multiple SSB bursts. One SS burst includes one or more SSBs, and one SS burst set includes one or more SSB bursts.

DL BM Related Beam Indication

A UE may be RRC-configured with a list of up to M candidate transmission configuration indication (TCI) states at least for the purpose of quasi co-location (QCL) indication, where M may be 64.

Each TCI state may be configured with one RS set. Each ID of DL RS at least for the purpose of spatial QCL (QCL Type D) in an RS set may refer to one of DL RS types such as SSB, P-CSI RS, SP-CSI RS, A-CSI RS, etc.

Initialization/update of the ID of DL RS(s) in the RS set used at least for the purpose of spatial QCL may be performed at least via explicit signaling.

Table 1 represents an example of TCI-State IE.

The TCI-State IE associates one or two DL reference signals (RSs) with corresponding quasi co-location (QCL) types.

TABLE 1
-- ASN1START
-- TAG-TCI-STATE-START

| | |
|---|---|
| TCI-State ::= | SEQUENCE [symbol] |

| | |
|---|---|
| tci-StateId | TCI-StateId, |

| | |
|---|---|
| qcl-Type1 | QCL-Info, |
| qcl-Type2 | QCL-Info |

...

}

| | |
|---|---|
| QCL-Info ::= | SEQUENCE { |

| | |
|---|---|
| cell | ServCellIndex |
| bwp-Id | BWP-Id |
| referenceSignal | CHOICE { |

| | |
|---|---|
| csi-rs | NZP-CSI-RS-ResourceId [symbol] |

| | |
|---|---|
| ssb | SSB-Index |

| [symbol] , | |
|---|---|
| qc1-Type | ENUMERATED {typeA, typeB, typeC, typeD}, |

...

[symbol]

-- TAG-TCI-STATE-STOP
-- ASN1STOP [symbol]
indicates data missing or illegible when filed

In Table 1, bwp-Id parameter represents a DL BWP where the RS is located, cell parameter represents a carrier where the RS is located, and reference signal parameter represents reference antenna port(s) which is a source of quasi co-location for corresponding target antenna port(s) or a reference signal including the one. The target antenna port(s) may be CSI-RS, PDCCH DMRS, or PDSCH DMRS. As an example, in order to indicate QCL reference RS information on NZP CSI-RS, the corresponding TCI state ID may be indicated to NZP CSI-RS resource configuration information. As another example, in order to indicate QCL reference information on PDCCH DMRS antenna port(s), the TCI state ID may be indicated to each CORESET configuration. As another example, in order to indicate QCL reference information on PDSCH DMRS antenna port(s), the TCI state ID may be indicated via DCI.

Quasi-Co Location (QCL)

The antenna port is defined so that a channel over which a symbol on an antenna port is conveyed can be inferred from a channel over which another symbol on the same antenna port is conveyed. When properties of a channel over which a symbol on one antenna port is conveyed can be inferred from a channel over which a symbol on another antenna port is conveyed, the two antenna ports may be considered as being in a quasi co-located or quasi co-location (QC/QCL) relationship.

The channel properties include one or more of delay spread, Doppler spread, frequency/Doppler shift, average received power, received timing/average delay, and spatial RX parameter. The spatial Rx parameter means a spatial (reception) channel property parameter such as an angle of arrival.

The UE may be configured with a list of up to M TCI-State configurations within the higher layer parameter PDSCH-Config to decode PDSCH according to a detected PDCCH with DCI intended for the corresponding UE and a given serving cell, where M depends on UE capability.

Each TCI-State contains parameters for configuring a quasi co-location relationship between one or two DL reference signals and the DM-RS ports of the PDSCH.

The quasi co-location relationship is configured by the higher layer parameter qcl-Type1 for the first DL RS and qcl-Type2 for the second DL RS (if configured). For the situation of two DL RSs, the QCL types are not be the same, regardless of whether the references are to the same DL RS or different DL RSs.

The quasi co-location types corresponding to each DL RS are given by the higher layer parameter qcl-Type of QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if a target antenna port is a specific NZP CSI-RS, the corresponding NZP CSI-RS antenna ports may be indicated/configured to be QCLed with a specific TRS in terms of QCL-TypeA and with a specific SSB in terms of QCL-TypeD. The UE receiving the indication/configuration may receive the corresponding NZP CSI-RS using the Doppler or delay value measured in the QCL-TypeA TRS and apply the Rx beam used for QCL-TypeD SSB reception to the reception of the corresponding NZP CSI-RS reception.

The UE may receive an activation command by MAC CE signaling used to map up to eight TCI states to the codepoint of the DCI field ‘Transmission Configuration Indication’.

UL BM Procedure

A UL BM may be configured such that beam reciprocity (or beam correspondence) between Tx beam and Rx beam is established or not established depending on the UE implementation. If the beam reciprocity between Tx beam and Rx beam is established in both a base station and a UE, a UL beam pair may be adjusted via a DL beam pair. However, if the beam reciprocity between Tx beam and Rx beam is not established in any one of the base station and the UE, a process for determining the UL beam pair is necessary separately from determining the DL beam pair.

Even when both the base station and the UE maintain the beam correspondence, the base station may use a UL BM procedure for determining the DL Tx beam even if the UE does not request a report of a (preferred) beam.

The UM BM may be performed via beamformed UL SRS transmission, and whether to apply UL BM of a SRS resource set is configured by the (higher layer parameter) usage. If the usage is set to ‘BeamManagement (BM)’, only one SRS resource may be transmitted to each of a plurality of SRS resource sets in a given time instant.

The UE may be configured with one or more sounding reference symbol (SRS) resource sets configured by (higher layer parameter) SRS-ResourceSet (via higher layer signaling, RRC signaling, etc.). For each SRS resource set, the UE may be configured with K≥1 SRS resources (higher later parameter SRS-resource), where K is a natural number, and a maximum value of K is indicated by SRS_capability.

In the same manner as the DL BM, the UL BM procedure may be divided into a UE's Tx beam sweeping and a base station's Rx beam sweeping.

FIG. 13 illustrates an example of an UL BM procedure using a SRS.

More specifically, FIG. 13(a) illustrates an Rx beam determination procedure of a base station, and FIG. 13(b) illustrates a Tx beam sweeping procedure of a UE.

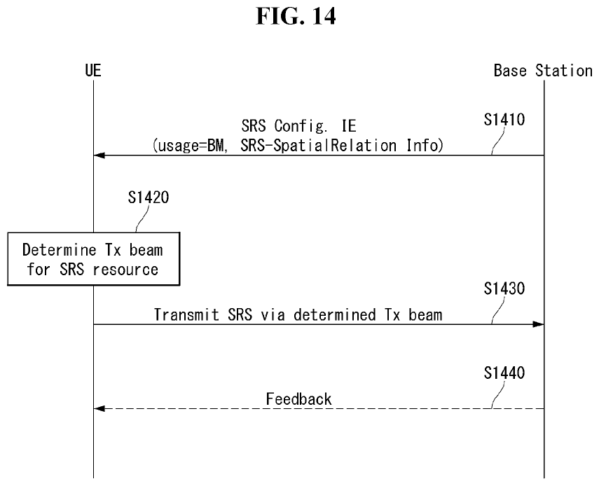

FIG. 14 is a flow chart illustrating an example of an UL BM procedure using a SRS.
The UE receives, from the base station, RRC signaling (e.g., SRS-Config IE) including (higher layer parameter) usage parameter set to ‘beam management’ in S1410.

Table 2 represents an example of SRS-Config information element (IE), and the SRS-Config IE is used for SRS transmission configuration. The SRS-Config IE contains a list of SRS-Resources and a list of SRS-Resource sets. Each SRS resource set means a set of SRS resources.

The network may trigger transmission of the SRS resource set using configured aperiodicSRS-ResourceTrigger (L1 DCI).

TABLE 2
-- ASN1START
-- TAG-MAC-CELL-GROUP-CONFIG-START

| | |
|---|---|
| SRS-Config [symbol] | SEQUENCE [symbol] |

| | |
|---|---|
| srs-ResourceSetToReleaseList | SEQUENCE (SIZE(1..maxNrof [symbol] |

| | |
|---|---|
| ResourceSets)) OF SRS-ResourceSet [symbol] | OPTIONAL, -- Need N |

| | |
|---|---|
| srs-ResourceSetToAddModList | SEQUENCE (SIZE(1.. [symbol] |

| | |
|---|---|
| ResourceSets)) OF SRS-ResourceSet | OPTIONAL, --Need N |

| | |
|---|---|
| srs-ResourceToReleaseList | SEQUENCE (SIZE (1..maxNrofSRS- |

| | |
|---|---|
| Resources)) OF SRS-ResourceId | OPTIONAL, -- Need N |

| | |
|---|---|
| srs-ResourceToAddModList | SEQUENCE (SIZE(1..maxNrofSRS- |

| | |
|---|---|
| Resources)) OF SRS-Resource | OPTIONAL, -- Need N |

| | |
|---|---|
| tpc-Accumulation | ENUMERATED {disabled} |

...

[symbol]

| | |
|---|---|
| SRS-ResourceSet ::= | SEQUENCE [symbol] |

| | |
|---|---|
| srs-ResourceSetId | SRS-ResourceSetId, |
| srs-ResourceIdList | SEQUENCE (SIZE (1..maxNrofSRS- |

| | |
|---|---|
| ResourcesPerSet)) OF SRS-ResourceId | OPTIONAL, -- Cond Setup |

| | |
|---|---|
| resourceType | CHOICE { |

| | |
|---|---|
| aperiodic | SEQUENCE [symbol] |

| | |
|---|---|
| aperiodicSRS-ResourceTrigger | INTEGER (1..maxNrofSRS- |

TriggerStates−1),

| | |
|---|---|
| [symbol] -R3 | [symbol] F-CSI-RS-ResourceId |

| | |
|---|---|
| slotOf [symbol] | INTEGER (1...32) |

...

| [symbol] , | |
|---|---|
| semi-persistent | SEQUENCE { |

| | |
|---|---|
| associatedCSI-RS | N [symbol] P-CSI-RS-ResourceId |

...

| [symbol] , | |
|---|---|
| periodic | SEQUENCE [symbol] |

| | |
|---|---|
| associatedCSI-RS | N [symbol] P-CSI-RS-ResourceId |

...

[symbol]

| [symbol] , | |
|---|---|
| usage | ENUMERATED {beamManagement, |

codebook, nonCodebook, antennaSwitching

[symbol]

| | |
|---|---|
| alpha | Alpha |
| p [symbol] | INTEGER (−2 [symbol] 24) |
| pa [symbol] Reference [symbol] | CHOICE [symbol] |

| | |
|---|---|
| ssb-Index | SSB-Index, |
| [symbol] - [symbol] -Index | N [symbol] P-CSI-RS-ResourceId |

| | |
|---|---|
| SRS-SpatialRelationInfo ::= | SEQUENCE [symbol] |

| | |
|---|---|
| servingCellId | ServCellIndex |

| | |
|---|---|
| referenceSignal | Choice [symbol] |

| | |
|---|---|
| ssb-Index | SSB-Index, |
| [symbol] -RS-Index | N [symbol] P-CSI-R [symbol] -ResourceId, |

| | |
|---|---|
| [symbol] | SEQUENCE [symbol] |

| | |
|---|---|
| resourceId | SRS-ResourceId, |

| | |
|---|---|
| [symbol] | [symbol] |

}

}

}

| | |
|---|---|
| SRS-ResourceId ::= | INTEGER (0..maxNro [symbol] SRS-Resources [symbol] |

[symbol]

indicates data missing or illegible when filed

In Table 2, usage refers to a higher layer parameter to indicate whether the SRS resource set is used for beam management or is used for codebook based or non-codebook based transmission. The usage parameter corresponds to L1 parameter ‘SRS-SetUse’. ‘spatialRelationInfo’ is a parameter representing a configuration of spatial relation between a reference RS and a target SRS. The reference RS may be SSB, CSI-RS, or SRS which corresponds to L1 parameter ‘SRS-SpatialRelationInfo’. The usage is configured per SRS resource set.
The UE determines the Tx beam for the SRS resource to be transmitted based on SRS-SpatialRelation Info contained in the SRS-Config IE in S1420. The SRS-SpatialRelation Info is configured per SRS resource and indicates whether to apply the same beam as the beam used for SSB, CSI-RS, or SRS per SRS resource. Further, SRS-SpatialRelationInfo may be configured or not configured in each SRS resource.
If the SRS-SpatialRelationInfo is configured in the SRS resource, the same beam as the beam used for SSB, CSI-RS or SRS is applied for transmission. However, if the SRS-SpatialRelationInfo is not configured in the SRS resource, the UE randomly determines the Tx beam and transmits the SRS via the determined Tx beam in S1430.

More specifically, for P-SRS with ‘SRS-ResourceConfigType’ set to ‘periodic’:

i) if SRS-SpatialRelationInfo is set to ‘SSB/PBCH,’ the UE transmits the corresponding SRS resource with the same spatial domain transmission filter (or generated from the corresponding filter) as the spatial domain Rx filter used for the reception of the SSB/PBCH; or

ii) if SRS-SpatialRelationInfo is set to ‘CSI-RS,’ the UE transmits the SRS resource with the same spatial domain transmission filter used for the reception of the periodic CSI-RS or SP CSI-RS; or

iii) if SRS-SpatialRelationInfo is set to ‘SRS,’ the UE transmits the SRS resource with the same spatial domain transmission filter used for the transmission of the periodic SRS.

Even if ‘SRS-ResourceConfigType’ is set to ‘SP-SRS’ or ‘AP-SRS,’ the beam determination and transmission operations may be applied similar to the above.
Additionally, the UE may receive or may not receive feedback for the SRS from the base station, as in the following three situations in S1440.

i) If Spatial_Relation_Info is configured for all the SRS resources within the SRS resource set, the UE transmits the SRS with the beam indicated by the base station. For example, if the Spatial_Relation_Info indicates all the same SSB, CRI, or SRI, the UE repeatedly transmits the SRS with the same beam. This case corresponds to FIG. 13(a) as the usage for the base station to select the Rx beam.

ii) The Spatial_Relation_Info may not be configured for all the SRS resources within the SRS resource set. In this situation, the UE may perform transmission while freely changing SRS beams. That is, this situation corresponds to FIG. 13(b) as the usage for the UE to sweep the Tx beam.

iii) The Spatial_Relation_Info may be configured for only some SRS resources within the SRS resource set. In this situation, the UE may transmit the configured SRS resources with the indicated beam, and transmit the SRS resources, for which Spatial_Relation_Info is not configured, by randomly applying the Tx beam.

### J. Main Embodiments

The above-described 5G communication technology can be applied in conjunction with methods according to the present invention to be described below, or can be supplemented to further specify or clarify technical features of methods described in the present invention. In addition, a method for controlling an autonomous vehicle described in the present invention can be applied in conjunction with 3G, 4G and/or 6G communication services as well as the above-described 5G communication technology.

The above-described beam management technology can be applied in conjunction with methods according to the present invention to be described below. The functions/operations of a base station described in relation to the beam management may be performed by a Tx UE, a Tx vehicle (hereinafter, first vehicle), or an autonomous vehicle. The functions/operations of a UE described in relation to the beam management may be performed by an Rx UE, an Rx vehicle (hereinafter, second vehicle), or a target vehicle. However, the present disclosure is not limited thereto.

In the following description, all the Tx UE, the Tx vehicle, the first vehicle, and the autonomous vehicle may include the same components and perform the same functions. In addition, all the Rx UE, the Rx vehicle, the second vehicle, and the target vehicle may include the same components and perform the same functions.

Communication Connection Establishment between Autonomous Vehicle (Tx UE) and Target Vehicle (Rx UE)

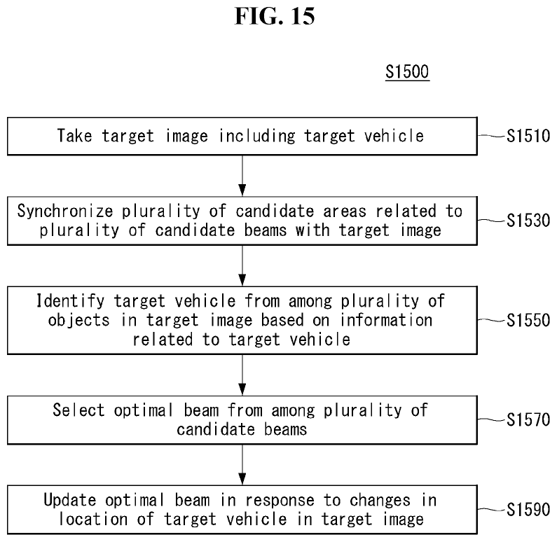

First, before performing step S1500 illustrated in FIG. 15, an autonomous vehicle establishes communication connection with a target vehicle through one of the following first to fourth method examples.

As a first example, an autonomous vehicle may establish (start) communication connection with a target vehicle using discovery technology of long term evolution (LTE). That is, the autonomous vehicle may start mmWave (5G) communication using discovery technology of LTE device-to-device (D2D) communication and/or vehicle-to-everything (V2X) communication. For example, in the LTE D2D/V2X technology, an autonomous vehicle (Tx UE) and/or a target vehicle (Rx UE) are allocated a resource pool (radio frequency/time resources) per each ID of services (e.g., sensor data exchange service, forward traffic data sharing service, etc. using mmWave) pre-allocated by a base station/network. The Tx UE and/or the Rx UE may periodically discover neighboring UEs using the allocated resource pool.

When the two UEs recognize each other after the discovery procedure, the two UEs may start mmWave communication. Specifically, the Tx UE that is a preceding vehicle of the Rx UE may send a collision warning message to the Rx UE, which is a subsequent vehicle of the Tx UE, using the resource pool, in order to share forward traffic data. In the same manner, the Rx UE may receive the collision warning message using the resource pool. The Rx UE may send a response message to the Tx UE in the same manner. As above, the Tx UE and the Rx UE may discover the opponent UE.

After the discovery procedure, the Tx UE may transmit a Tx beam for beam pairing to the Rx UE via mmWave based on the reception of the response message, and may share forward traffic data through the Tx beam.

As a second example, an autonomous vehicle may start communication connection with a target vehicle by mixedly using user interface (UI) and existing communication technology. The autonomous vehicle may select a specific vehicle which wants to start communication based on selection of a driver using UI in the autonomous vehicle. For example, the autonomous vehicle may obtain selection of a driver using UI such that a user on a UI screen included in the autonomous vehicle touches the specific vehicle, recognizes a voice speaking a vehicle number of the specific vehicle from the user, obtains a gesture indicating the specific vehicle from the user, indicates the specific vehicle on AR/VR, or recognizes an utterance of features (e.g., black car) of the specific vehicle. As described above, if the autonomous vehicle obtains the driver's selection, the autonomous vehicle may select a specific target vehicle using an artificial intelligence (AI) technology. Herein, the autonomous vehicle may identify the specific target vehicle using a number plate of the target vehicle or QR code information related to the target vehicle. For example, the autonomous vehicle may sense the QR code information of the target vehicle in infrared/visible area. For example, the QR code information of the target vehicle may be attached to the surface of the target vehicle.

As described above, after the autonomous vehicle identifies the target vehicle, the autonomous vehicle may start mmWave communication with the selected target vehicle using the existing communication technology. For example, the autonomous vehicle may transmit vehicle identification information to the selected target vehicle through LTE call, and the selected target vehicle may start mmWave communication with an autonomous vehicle of neighboring vehicles.

As a third example, an autonomous vehicle may start communication connection using mmWave technology. Each of an autonomous vehicle (Tx UE) and a target vehicle (Rx UE) may discover an opponent vehicle depending on a predetermined period using frequency/time radio resources of mmWave band allocated to each ID of pre-defined services (e.g., sensor data exchange service, traffic data sharing service, etc.) before mmWave communication. For example, when the autonomous vehicle precedes the target vehicle and selects the target vehicle through the above second example, the autonomous vehicle may transmit a Tx beam for beam pairing to the target vehicle if it is mmWave communication period.

Subsequently, the target vehicle (Rx UE) may measure a plurality of candidate beams 1, 2, 3, 4, 5 and 6, and select a Tx beam indicating the largest signal among the measured candidate beams. The target vehicle may transmit a signal or a message related to identification number of the selected Tx beam to the Tx UE.

Next, the Tx UE may detect a signal or a message of the Rx UE and start communication with the Rx UE.

As a fourth example, an autonomous vehicle may start communication connection with a target vehicle using discovery and vehicle list. Specifically, a server/network may indicate, to a Tx UE and an Rx UE, a list of vehicles capable of performing mmWave communication among neighbor vehicles using a discovery technology of existing LTE D2D/V2X communication or a discovery technology of 5G NR. For example, if the list of vehicles is indicated, UI of the autonomous vehicle may mark vehicle candidates. Herein, the UI may represent vehicle information in various types of UI, and a driver may select one among these vehicles. Afterwards, the autonomous vehicle may start communication connection with a vehicle selected by the driver vie the UI.

FIG. 15 is a flow chart illustrating a method for controlling an autonomous vehicle according to an embodiment of the present disclosure.

A method for controlling an autonomous vehicle illustrated in FIG. 15 may be performed by the first communication device 910 and the second communication device 920 of FIG. 1, the autonomous vehicle of FIG. 3, the autonomous vehicle 1 and the autonomous vehicle 2 of FIG. 4, the vehicle 10 and the autonomous device 260 of FIGS. 5 and 6, the processor 170 of FIGS. 7 and 8, the vehicle of FIG. 10, the Tx of FIG. 12, the base station and the UE of FIG. 13, or the UE or the base station of FIG. 14. However, although it is described that the autonomous vehicle performs the method for controlling the autonomous vehicle according to the present disclosure for convenience of explanation, the present disclosure is not limited thereto.

As illustrated in FIG. 15, a method S1500 for controlling an autonomous vehicle according to an embodiment of the present disclosure includes steps S1510 to S1590, and the steps are described in detail below.

First, the autonomous vehicle may take a target image including a target vehicle with a camera in S1510. For example, the autonomous vehicle may photograph a plurality of objects including the target vehicle using the camera included in the autonomous vehicle.

Subsequently, the autonomous vehicle may synchronize a plurality of candidate areas related to a plurality of candidate beams with the target image in S1530. For example, the autonomous vehicle may transmit the plurality of candidate beams in a direction in which the target vehicle is located, and may synchronize a plurality of candidate areas respectively related to the transmitted plurality of candidate beams with a plurality of areas of the target image.

Next, the autonomous vehicle may identify the target vehicle from among a plurality of objects in the target image based on information related to the target vehicle in S1550. For example, the autonomous vehicle may identify the target vehicle from among the plurality of objects included in the target image based on a received signal strength of each of the plurality of candidate beams transmitted from the target vehicle. For example, the autonomous vehicle may identify the target vehicle from among the plurality of objects included in the target image based on location information of the target vehicle. For example, the autonomous vehicle may identify the target vehicle among the plurality of objects included in the target image based on a response of the target vehicle to a target vehicle specific signal transmitted to the target vehicle. For example, the autonomous vehicle may identify the target vehicle among the plurality of objects included in the target image based on a reception angle of the target vehicle and/or a directional angle of the autonomous vehicle for the Tx beam transmitted from the target vehicle. For example, the autonomous vehicle may identify the target vehicle among the plurality of objects included in the target image based on identification information of the target vehicle transmitted from the target vehicle.

Subsequently, the autonomous vehicle may select an optimal beam from among the plurality of candidate beams in S1570. For example, the autonomous vehicle may select, as the optimal beam, a candidate beam corresponding to a target area in which the identified target vehicle is located in the target image.

Next, the autonomous vehicle may update the optimal beam in response to changes in the location of the target vehicle in the target image in S1590. For example, if the target vehicle identified in the step S1570 moves from a first target area corresponding to a first candidate beam to a second target area, the autonomous vehicle may update the optimal beam to a second candidate beam corresponding to the second target area.

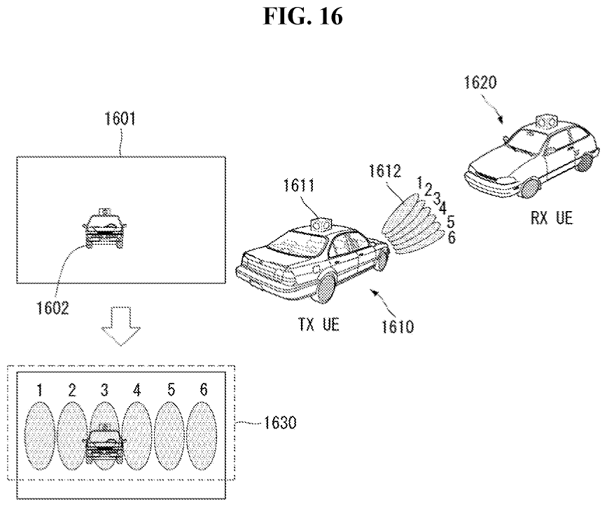

FIG. 16 illustrates a process for a Tx UE to take a target image in accordance with an embodiment of the present disclosure.

As illustrated in FIG. 16, an autonomous vehicle (Tx UE) 1610 may photograph directions, in which a plurality of candidate beams 1612 are transmitted, using a camera 1611 included in the autonomous vehicle 1610. Herein, the plurality of candidate beams 1612 may be transmitted in a direction in which a target vehicle 1620 is located. The autonomous vehicle 1610 may acquire a target image 1601, and at least one object 1602 including the target vehicle 1620 may be included in the target image 1601.

Subsequently, the autonomous vehicle 1610 may synchronize the target image 1601 with a plurality of candidate areas 1630 related to the plurality of candidate beams.

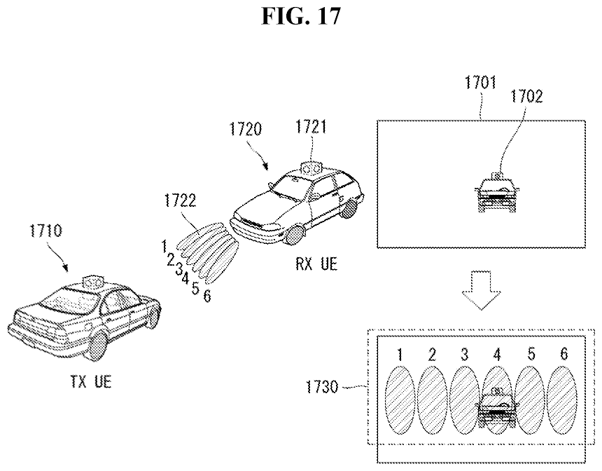

FIG. 17 illustrates a process for an Rx UE to take a target image in accordance with an embodiment of the present disclosure.

As illustrated in FIG. 17, an autonomous vehicle (Rx UE) 1720 may photograph directions, in which a plurality of candidate beams 1722 are transmitted, using a camera 1721 included in the autonomous vehicle 1720. Herein, the plurality of candidate beams 1722 may be transmitted in a direction in which a target vehicle 1710 is located. The autonomous vehicle 1720 may acquire a target image 1701, and at least one object 1702 including the target vehicle 1710 may be included in the target image 1701.

Subsequently, the autonomous vehicle 1720 may synchronize the target image 1701 with a plurality of candidate areas 1730 related to the plurality of candidate beams.

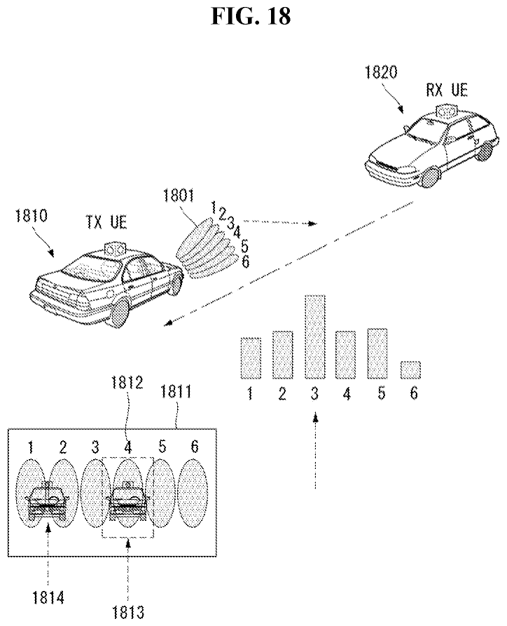

FIG. 18 illustrates an example where a Tx UE identifies a target vehicle based on a received signal strength of an Rx UE in accordance with an embodiment of the present disclosure.

As illustrated in FIG. 18, an autonomous vehicle (Tx UE) 1810 may transmit a plurality of candidate beams 1801 in a direction in which a target vehicle (Rx UE) 1820, in which communication connection is started, is located.

Herein, the autonomous vehicle 1810 may request information related to a received signal strength of each of a plurality of candidate beams from a target vehicle 1820, and may receive, from the target vehicle, information related to the received signal strength of each of the plurality of candidate beams.

Next, the autonomous vehicle 1810 may check that a candidate beam with a highest received signal strength in the target vehicle is #4 candidate beam among the plurality of candidate beams.

Subsequently, the autonomous vehicle 1810 may identify a target vehicle 1813 located in #4 area 1812 corresponding to the #4 candidate beam among at least one object (1813 and 1814) in a target image 1811.

Next, the autonomous vehicle 1810 may select the #4 candidate beam from among the plurality of candidate beams 1801 as an optimal beam, and transmit data to the target vehicle through the #4 candidate beam.

Subsequently, the autonomous vehicle 1810 may update the optimal beam from the #4 candidate beam to a new candidate beam corresponding to a target area corresponding to the location of the target vehicle, in response to changes in the location of the target vehicle in the target image.

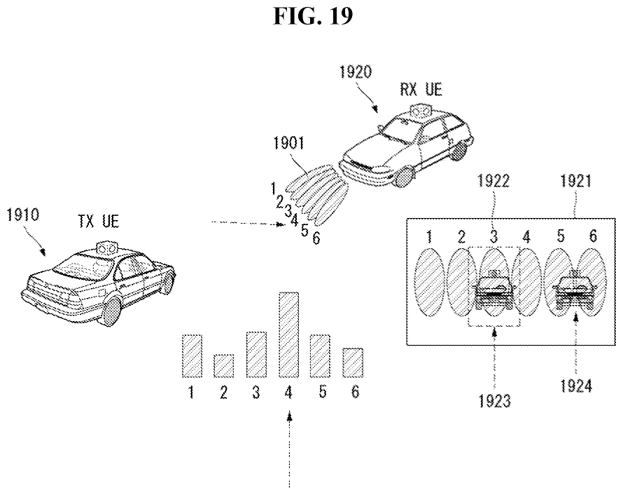

FIG. 19 illustrates an example where an Rx UE identifies a target vehicle based on a received signal strength of a Tx UE in accordance with an embodiment of the present disclosure.

As illustrated in FIG. 19, an autonomous vehicle (Rx UE) 1920 may receive a plurality of candidate beams 1901 from a direction in which a target vehicle (Tx UE) 1910, in which communication connection is started, is located.

Herein, the autonomous vehicle 1920 may check that a candidate beam with a highest received signal strength in the target vehicle is #3 candidate beam among the plurality of candidate beams.

Subsequently, the autonomous vehicle 1920 may identify a target vehicle 1923 located in #3 area 1922 corresponding to the #3 candidate beam among at least one object (1923 and 1924) in a target image 1921.

Next, the autonomous vehicle 1920 may select the #3 candidate beam from among the plurality of candidate beams 1901 as an optimal beam, and receive data from the target vehicle through the #3 candidate beam.

Next, the autonomous vehicle 1920 may update the optimal beam from the #3 candidate beam to a new candidate beam corresponding to a target area corresponding to the location of the target vehicle, in response to changes in the location of the target vehicle in the target image.

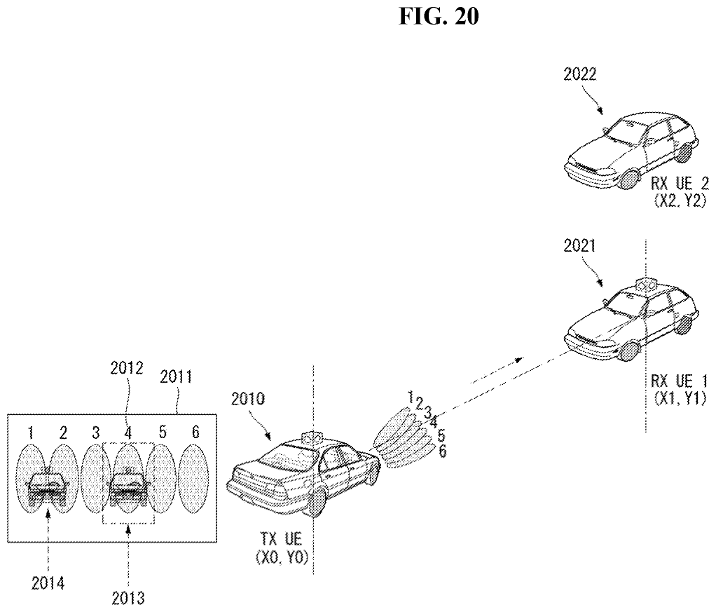

FIG. 20 illustrates an example where a Tx UE identifies a target vehicle based on a location of an Rx UE in accordance with an embodiment of the present disclosure.

As illustrated in FIG. 20, an autonomous vehicle 2010 may receive location information (X1, Y1) of a target vehicle 2021 from the target vehicle 2021 in a communication connection state with the target vehicle 2021 among a plurality of vehicles 2021 and 2022.

Subsequently, the autonomous vehicle 2010 may determine that the target vehicle is located in a direction, in which #4 candidate beam of the plurality of candidate beams is transmitted, using a location (X0, Y0) of the autonomous vehicle 2010 and the location information (X1, Y1) of the target vehicle 2021.

Next, the autonomous vehicle 2010 may identify a target vehicle 2013 located in #4 target area 2012 corresponding to the #4 candidate beam among a plurality of objects 2013 and 2014 in a target image 2011.

Subsequently, the autonomous vehicle 2010 may update an optimal beam in response to changes in the location of the target vehicle in the target image.

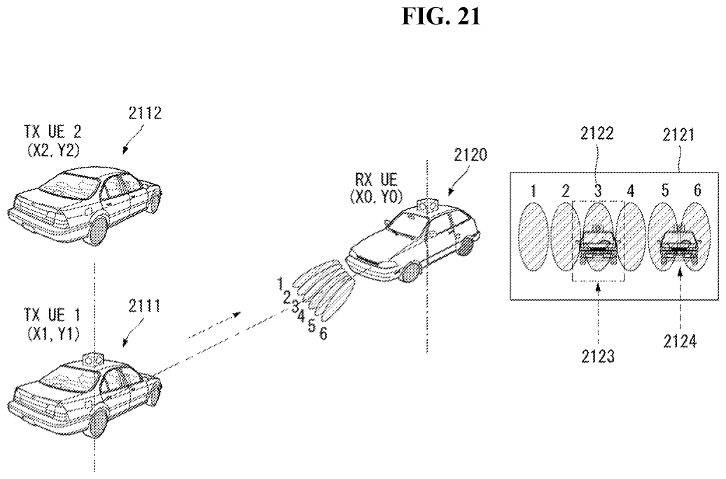

FIG. 21 illustrates an example where an Rx UE identifies a target vehicle based on a location of a Tx UE in accordance with an embodiment of the present disclosure.

As illustrated in FIG. 21, an autonomous vehicle (Rx UE) 2120 may receive location information (X1, Y1) of a target vehicle (Tx UE) 2111 from the target vehicle 2111 in a communication connection state with the target vehicle 2111 among a plurality of vehicles 2111 and 2112.

Subsequently, the autonomous vehicle 2120 may determine that the target vehicle is located in a direction, in which #3 candidate beam of the plurality of candidate beams is received, using a location (X0, Y0) of the autonomous vehicle 2120 and the location information (X1, Y1) of the target vehicle 2111.

Next, the autonomous vehicle 2120 may identify a target vehicle 2123 located in #3 target area 2122 corresponding to the #3 candidate beam among a plurality of objects 2123 and 2124 in a target image 2121.

Subsequently, the autonomous vehicle 2120 may update an optimal beam in response to changes in the location of the target vehicle in the target image.

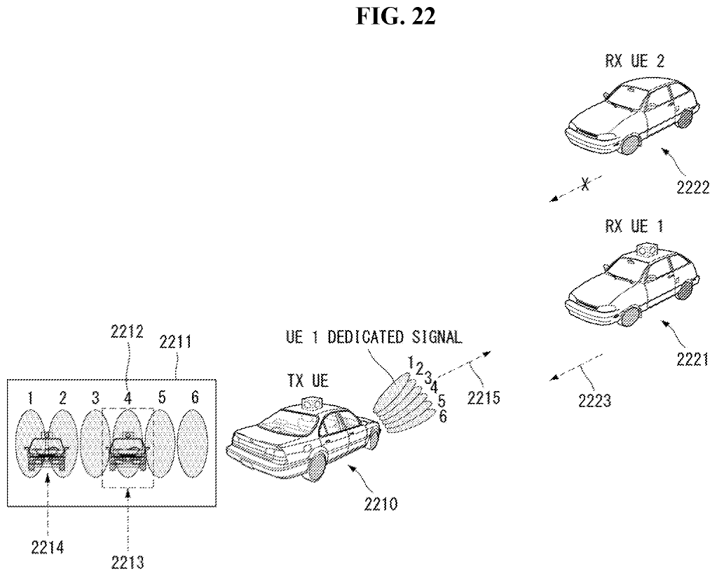

FIG. 22 illustrates an example where a Tx UE identifies a target vehicle based on a response to an Rx UE specific signal of an Rx UE in accordance with an embodiment of the present disclosure.

As illustrated in FIG. 22, an autonomous vehicle (Tx UE) 2210 may transmit a target vehicle specific signal (UE 1 DEDICATED SIGNAL) 2215 to a target vehicle (Rx UE) 2221 that is communication connected to it among a plurality of vehicles 2221 and 2222. The autonomous vehicle 2210 may receive a response signal 2223 to the target vehicle specific signal 2215.

Subsequently, the autonomous vehicle 2210 may determine, based on a direction in which the response signal 2223 to the target vehicle specific signal is received, #4 candidate area corresponding to #4 candidate beam that is located in the reception direction of the response signal among a plurality of objects 2213 and 2214 in a target image 2211, and may identify the target vehicle 2213 located in the #4 candidate area.

Next, the autonomous vehicle 2210 may update an optimal beam in response to changes in a location of the target vehicle in the target image.

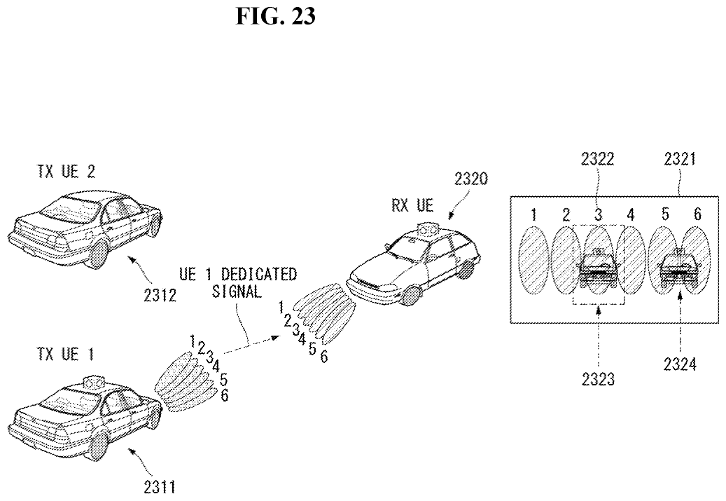

FIG. 23 illustrates an example where an Rx UE identifies a target vehicle based on an Rx UE specific signal of a Tx UE in accordance with an embodiment of the present disclosure.

As illustrated in FIG. 23, an autonomous vehicle (Rx UE) 2320 may receive a target vehicle specific signal (UE 1 DEDICATED SIGNAL) to a target vehicle (Tx UE) 2311 that is communication connected to it among a plurality of vehicles 2311 and 2312.

Subsequently, the autonomous vehicle 2320 may determine, based on a direction in which the target vehicle specific signal is received, #3 candidate area corresponding to #3 candidate beam that is located in the reception direction of the target vehicle specific signal among a plurality of objects 2323 and 2324 in a target image 2321, and may identify the target vehicle 2323 located in the #3 candidate area.

Next, the autonomous vehicle 2320 may update an optimal beam in response to changes in a location of the target vehicle in the target image.

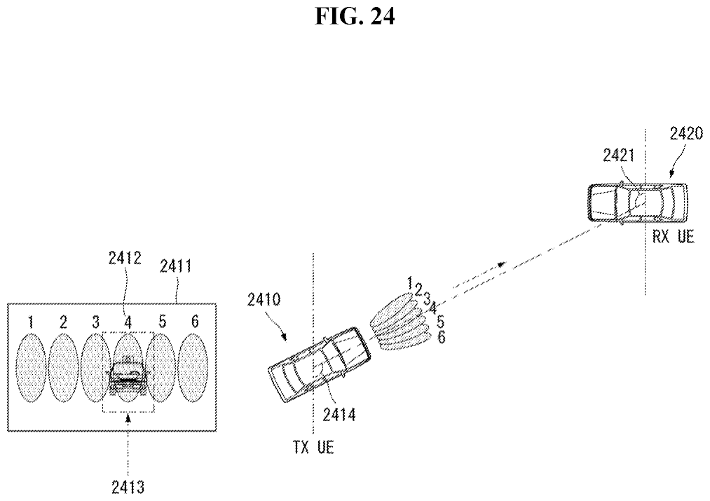

FIG. 24 illustrates an example where a Tx UE identifies a target vehicle based on a received signal angle of an Rx UE in accordance with an embodiment of the present disclosure.

As illustrated in FIG. 24, an autonomous vehicle (Tx UE) 2410 may transmit a specific signal to a target vehicle (Rx UE) 2420 in a state of starting communication connection with the target vehicle 2420, and may receive, from the target vehicle, information related to a received angle of the specific signal.

The autonomous vehicle 2410 may select #4 candidate beam from among a plurality of candidate beams using a received angle of the specific signal received from the target vehicle and a specific signal transmission angle of the autonomous vehicle.

Subsequently, the autonomous vehicle 2410 may identify, as a target vehicle, a vehicle 2413 located in #4 target area 2412 corresponding to the #4 candidate beam in a target image 2411 photographing the target vehicle.

Next, the autonomous vehicle 2410 may update an optimal beam in response to changes in a location of the target vehicle in the target image.

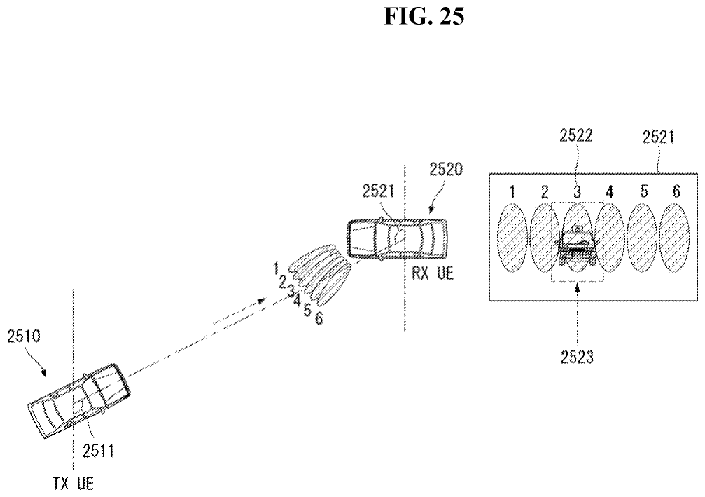

FIG. 25 illustrates an example where an Rx UE identifies a target vehicle based on a received signal angle of an Rx UE in accordance with an embodiment of the present disclosure.

As illustrated in FIG. 25, an autonomous vehicle (Rx UE) 2520 may receive a specific signal from a target vehicle (Tx UE) 2510 in a state of starting communication connection with the target vehicle 2510, and may receive, from the target vehicle, information related to a transmission angle of the specific signal.

The autonomous vehicle may select #3 candidate beam from among a plurality of candidate beams using a received angle of the specific signal and a specific signal transmission angle of the target vehicle.

Subsequently, the autonomous vehicle may identify, as a target vehicle, a vehicle 2523 located in #3 target area 2522 corresponding to the #3 candidate beam in a target image 2521 photographing the target vehicle.

Next, the autonomous vehicle may update an optimal beam in response to changes in a location of the target vehicle in the target image.

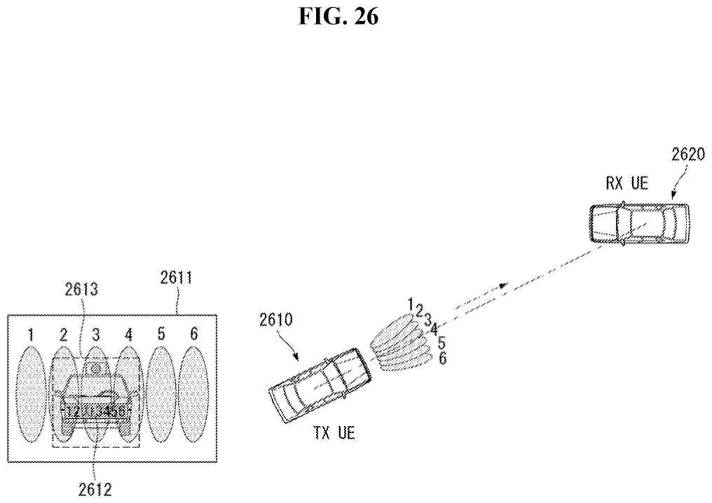

FIG. 26 illustrates an example of identifying a target vehicle using identification information on a target vehicle in accordance with an embodiment of the present disclosure.

As illustrated in FIG. 26, an autonomous vehicle 2610 may obtain identification information (e.g., vehicle number) of a target vehicle 2620 from the target vehicle 2620 that is communication connected to it.

Subsequently, the autonomous vehicle 2610 may identify a specific vehicle 2612 as the target vehicle using identification information (e.g., vehicle number ‘12CHA3456’) of the target vehicle 2620 in a target image 2611 photographing the target vehicle.

Next, the autonomous vehicle 2610 may update an optimal beam in response to changes in a location of the target vehicle in the target image.

Although not described above, an autonomous vehicle may identify a target vehicle based on a lidar transmission signal and a lidar reception signal. For example, the autonomous vehicle may transmit a lidar signal to the target vehicle using lidar included in the autonomous vehicle, and receive information related to a reception direction of the lidar signal from the target vehicle. Subsequently, the autonomous vehicle may identify the target vehicle in the target image using information related to a reception direction of the lidar signal received from the target vehicle. Further, the autonomous vehicle may identify the target vehicle in the target image based on a reception direction of the lidar signal received from the autonomous vehicle using the lidar included in the target vehicle.

Although not described above, the autonomous vehicle may perform multi input multi output (MIMO) communication using a plurality of antenna modules included in the target vehicle and the autonomous vehicle. According to the present disclosure, the autonomous vehicle may determine whether to perform the MIMO communication based on a specific signal transmission/reception angle, received signal strength, and/or location information of the target vehicle.

### K. Summary of Embodiments

Embodiment 1: a method for an autonomous vehicle to intelligently track a beam in an autonomous system may comprise initiating a communication connection with a target vehicle; taking a target image including the target vehicle; synchronizing a plurality of candidate areas respectively related to a plurality of transmit (Tx) beams transmitted to the target vehicle from the autonomous vehicle with the target image; identifying the target vehicle among a plurality of objects in the target image based on information related to the target vehicle; selecting an optimal beam related to the target vehicle from among the plurality of Tx beams; and updating the optimal beam based on changes in a location of the target vehicle in the target image.

Embodiment 2: in the Embodiment 1, the information related to the target vehicle may include information related to a received signal strength in the target vehicle for each of the plurality of Tx beams.

Embodiment 3: in the Embodiment 1, the information related to the target vehicle may include location information of the target vehicle.

Embodiment 4: in the Embodiment 1, the method may further comprise transmitting a first signal to the target vehicle, and the information related to the target vehicle may include information related to a reception direction for the first signal in the target vehicle.

Embodiment 5: in the Embodiment 4, the first signal may be a target vehicle specific signal for the target vehicle.

Embodiment 6: in the Embodiment 4, the method may further comprise receiving, from the target vehicle, a response signal to the first signal, and the information related to the target vehicle may include information related to a reception direction for the response signal in the autonomous vehicle.

Embodiment 7: in the Embodiment 1, the information related to the target vehicle may include identification information of the target vehicle.

Embodiment 8: an autonomous vehicle comprises a processor configured to control a function of the autonomous vehicle; a memory coupled to the processor and configured to store data for control of the autonomous vehicle; and a communication unit coupled to the processor and configured to transmit and receive data for control of the autonomous vehicle, in which the memory is configured to store instructions that allow the processor to initiate a communication connection with a target vehicle, take a target image including the target vehicle, synchronize a plurality of candidate areas respectively related to a plurality of transmit (Tx) beams transmitted to the target vehicle from the autonomous vehicle with the target image, identify the target vehicle among a plurality of objects in the target image based on information related to the target vehicle, select an optimal beam related to the target vehicle from among the plurality of Tx beams, and update the optimal beam based on changes in a location of the target vehicle in the target image.

Embodiment 9: in the Embodiment 8, the information related to the target vehicle may include information related to a received signal strength in the target vehicle for each of the plurality of Tx beams.

Embodiment 10: in the Embodiment 8, the information related to the target vehicle may include location information of the target vehicle.

Embodiment 11: in the Embodiment 8, the processor may be further configured to transmit a first signal to the target vehicle, and the information related to the target vehicle may include information related to a reception direction for the first signal in the target vehicle.

Embodiment 12: in the Embodiment 11, the first signal may be a target vehicle specific signal for the target vehicle.

Embodiment 13: in the Embodiment 11, the processor may be further configured to receive, from the target vehicle, a response signal to the first signal, and the information related to the target vehicle may include information related to a reception direction for the response signal in the autonomous vehicle.

Embodiment 14: in the Embodiment 8, the information related to the target vehicle may include identification information of the target vehicle.

Embodiment 15: a method for an autonomous vehicle to intelligently track a beam in an autonomous system may comprise initiating communication connection with a target vehicle; taking a target image including the target vehicle; synchronizing a plurality of candidate areas respectively related to a plurality of receive (Rx) beams received to the autonomous vehicle from the target vehicle with the target image; identifying the target vehicle among a plurality of objects in the target image based on information related to the target vehicle; selecting an optimal beam related to the target vehicle from among the plurality of Rx beams; and updating the optimal beam based on changes in a location of the target vehicle in the target image.

The present disclosure described above can be implemented using a computer-readable medium with programs recorded thereon for execution by a processor to perform various methods presented herein. The computer-readable medium includes all kinds of recording devices capable of storing data that is readable by a computer system. Examples of the computer-readable mediums include hard disk drive (HDD), solid state disk (SSD), silicon disk drive (SDD), ROM, RAM, CD-ROM, a magnetic tape, a floppy disk, an optical data storage device, the other types of storage mediums presented herein, and combinations thereof. If desired, the computer-readable medium may be realized in the form of a carrier wave (e.g., transmission over Internet). Thus, the foregoing description is merely an example and is not to be considered as limiting the present disclosure. The scope of the present disclosure should be determined by rational interpretation of the appended claims, and all changes within the equivalent range of the present disclosure are included in the scope of the present disclosure.

What is claimed is:

1. A method for an autonomous vehicle to intelligently track a beam in an autonomous system, the method comprising:
initiating a communication connection with a target vehicle;
taking a target image including the target vehicle;
synchronizing a plurality of candidate areas respectively related to a plurality of transmit (Tx) beams with the target image, the plurality of Tx beams transmitted to the target vehicle from the autonomous vehicle;
identifying the target vehicle from among one or more objects in the target image based on information related to the target vehicle;
selecting an optimal beam related to the target vehicle from among the plurality of Tx beams; and
updating the optimal beam to be set to another Tx beam among the plurality of Tx beams based on a change in a location of the target vehicle in the target image.

2. The method of claim 1, wherein the information related to the target vehicle includes information related to a received signal strength in the target vehicle for each of the plurality of Tx beams.

3. The method of claim 2, wherein the updating the optimal beam includes selecting a Tx beam that has a highest received signal strength in the target vehicle among the plurality of Tx beams.

4. The method of claim 1, wherein the information related to the target vehicle includes location information of the target vehicle.

5. The method of claim 1, further comprising transmitting a first signal to the target vehicle,
wherein the information related to the target vehicle includes information related to a reception direction of the first signal in the target vehicle.

6. The method of claim 5, wherein the first signal is a target vehicle specific signal for the target vehicle.

7. The method of claim 5, further comprising receiving, from the target vehicle, a response signal to the first signal,
wherein the information related to the target vehicle includes information related to a reception direction of the response signal in the autonomous vehicle.

8. The method of claim 1, wherein the information related to the target vehicle includes identification information of the target vehicle.

9. An autonomous vehicle comprising:
a processor configured to control a function of the autonomous vehicle;
a memory coupled to the processor and configured to store data for control of the autonomous vehicle;
a camera configured to capture an image; and
a communication unit coupled to the processor and configured to transmit and receive data for control of the autonomous vehicle,
wherein the processor is further configured to:
take a target image including the target vehicle,
synchronize a plurality of candidate areas respectively related to a plurality of transmit (Tx) beams with the target image, the plurality of Tx beams transmitted to the target vehicle from the autonomous vehicle,
identify the target vehicle from among one or more objects in the target image based on information related to the target vehicle,
select an optimal beam related to the target vehicle from among the plurality of Tx beams, and
update the optimal beam to be set to another Tx beam among the plurality of Tx beams based on a change in a location of the target vehicle in the target image.

10. The autonomous vehicle of claim 9, wherein the information related to the target vehicle includes information related to a received signal strength in the target vehicle for each of the plurality of Tx beams.

11. The autonomous vehicle of claim 10, wherein processor is further configured to update the optimal beam by selecting a Tx beam that has a highest received signal strength in the target vehicle among the plurality of Tx beams.

12. The autonomous vehicle of claim 9, wherein the information related to the target vehicle includes location information of the target vehicle.

13. The autonomous vehicle of claim 9, wherein the processor is further configured to transmit a first signal to the target vehicle,
wherein the information related to the target vehicle includes information related to a reception direction of the first signal in the target vehicle.

14. The autonomous vehicle of claim 13, wherein the first signal is a target vehicle specific signal for the target vehicle.

15. The autonomous vehicle of claim 13, wherein the processor is further configured to receive, from the target vehicle, a response signal to the first signal,
wherein the information related to the target vehicle includes information related to a reception direction of the response signal in the autonomous vehicle.

16. The autonomous vehicle of claim 9, wherein the information related to the target vehicle includes identification information of the target vehicle.

17. A method for an autonomous vehicle to intelligently track a beam in an autonomous system, the method comprising:
initiating a communication connection with a target vehicle;
taking a target image including the target vehicle;
synchronizing a plurality of candidate areas respectively related to a plurality of receive (Rx) beams with the target image, the plurality of Rx beams received by the autonomous vehicle from the target vehicle;
identifying the target vehicle among one or more objects in the target image based on information related to the target vehicle;
selecting an optimal beam related to the target vehicle from among the plurality of Rx beams; and
updating the optimal beam to be set to another Rx beam among the plurality of Rx beams based on a change in a location of the target vehicle in the target image.

18. The method of claim 17, wherein the information related to the target vehicle includes information related to a received signal strength in the target vehicle for each of the plurality of Rx beams.

19. The method of claim 18, wherein the updating the optimal beam includes selecting an Rx beam that has a highest received signal strength in the target vehicle among the plurality of Rx beams.

20. The method of claim 17, further comprising receiving a first signal by the target vehicle,
wherein the information related to the target vehicle includes information related to a reception direction of the first signal in the target vehicle.
